(19) United States
(12) Patent Application Publication
(10) Pub. No.: US 2001/0021909 A1
(43) Pub. Date: Sep. 13, 2001

(54) Conversation processing apparatus and method, and recording medium therefor

(76) Inventors: Hideki Shimomura, Kanagawa (JP); Takashi Toyoda, Tokyo (JP); Katsuki Minamino, Tokyo (JP); Osamu Hanagata, Tokyo (JP); Hiroki Saijo, Chiba (JP); Toshiya Ogura, Saitama (JP)

Correspondence Address: William S. Frommer, Esq., FROMMER LAWRENCE & HAUG LLP, 745 Fifth Avenue, New York, NY, 10151, US

(21) Appl. No.: 09/749,205

(22) Filed: Dec. 27, 2000

(30) Foreign Application Priority Data
Dec. 28, 1999 (JP) 11-375767

(51) Int. Cl. G10L 21/00

(52) U.S. Cl. 704/275

(57) ABSTRACT

A conversation processing apparatus and method determines whether to change the topic. If the determination is affirmative, the degree of association between a present topic being discussed and a candidate topic stored in a memory is computed with reference to a degree of association table. Based on the computation result, a topic with the highest degree of association is selected as a subsequent topic. The topic is changed from the present topic to the subsequent topic. The degree of association table used to select the subsequent topic is updated.

### BACKGROUND OF THE INVENTION

1. Field of the Invention

The present invention relates to conversation processing apparatuses and methods, and to recording media therefor, and more specifically, relates to a conversation processing apparatus and method, and to a recording medium suitable for a robot for carrying out a conversation with a user or the like.

2. Description of the Related Art

Recently, a number of robots (including teddy bears and dolls) for outputting synthesized sounds when a touch sensor thereof is pressed are being manufactured as toys and the like.

Fixed (task oriented) conversation systems are used with computers to make reservations for airline tickets, offer travel guide services, and the like. These systems are intended to hold predetermined conversations, but cannot hold natural conversations, such as chatting, with human beings. Efforts have been made to achieve a natural conversation, including chatting, between computers and human beings. One effort is an experimental attempt called Eliza (James Allen: “Natural Language Understanding”, pp. 6 to 9).

The above-described Eliza can hardly understand the content of a conversation with a human being (user). In other words, Eliza merely parrots the words spoken by the user. Hence, the user soon becomes bored.

In order to produce a natural conversation which will not bore the user, it is necessary not to continue to discuss one topic for a long period of time, and it is necessary not to change topics too frequently. Specifically, a natural change of topic is an important element in holding a natural conversation. When changing the topic of conversation, it is more desirable to change to an associated topic rather than to a totally different topic in order to hold a more natural conversation.

### SUMMARY OF THE INVENTION

Accordingly, it is an object of the present invention to select a closely related topic from among stored topics when changing the topic and to carry out a natural conversation with a user by changing to the selected topic.

In accordance with an aspect of the present invention, a conversation processing apparatus for holding a conversation with a user is provided including a first storage unit for storing a plurality of pieces of first information concerning a plurality of topics. A second storage unit stores second information concerning a present topic being discussed. A determining unit determines whether to change the topic. A selection unit selects, when the determining unit determines to change the topic, a new topic to change to from among the topics stored in the first storage unit. A changing unit reads the first information concerning the topic selected by the selection unit from the first storage unit and changes the topic by storing the read information in the second storage unit.

The conversation processing apparatus may further include a third storage unit for storing a topic which has been discussed with the user in a history. The selection unit may select, as the new topic, a topic other than those stored in the history in the third storage unit.

When the determination unit determines to change the topic in response to the change of topic introduced by the user, the selection unit may select a topic which is the most closely related to the topic introduced by the user from among the topics stored in the first storage unit.

The first information and the second information may include attributes which are respectively associated therewith. The selection unit may select the new topic by computing a value based on association between the attributes of each piece of the first information and the attributes of the second information and selecting the first information with the greatest value as the new topic, or by reading a piece of the first information, computing the value based on the association between the attributes of the first information and the attributes of the second information, and selecting the first information as the new topic if the first information has a value greater than a threshold.

The attributes may include at least one of a keyword, a category, a place, and a time.

The value based on the association between the attributes of the first information and the attributes of the second information may be stored in the form of a table, and the table may be updated.

When selecting the new topic using the table, the selection unit may weight the value in the table for the first information having the same attributes as those of the second information and may use the weighted table, thereby selecting the new topic.

The conversation may be held in one of orally and in written form.

The conversation processing apparatus may be included in a robot.

In accordance with another aspect of the present invention, a conversation processing method for a conversation processing apparatus for holding a conversation with a user is provided including a storage controlling step of controlling storage of information concerning a plurality of topics. In a determining step, whether to change the topic is determined. In a selecting step, when the topic is determined to be changed in the determining step, a topic which is determined to be appropriate is selected as a new topic from among the topics stored in the storage controlling step. In a changing step, the information concerning the topic selected in the selecting step is used as information concerning the new topic, thereby changing the topic.

In accordance with another aspect of the present invention, a recording medium having recorded thereon a computer-readable conversation processing program for holding a conversation with a user is provided. The program includes a storage controlling step of controlling storage of information concerning a plurality of topics. In a determining step, whether to change the topic is determined. In a selecting step, when the topic is determined to be changed in the determining step, a topic which is determined to be appropriate is selected as a new topic from among the topics stored in the storage controlling step. In a changing step, the information concerning the topic selected in the selecting step is used as information concerning the new topic, thereby changing the topic.

According to the present invention, it is possible to hold a natural and enjoyable conversation with a user.

### BRIEF DESCRIPTION OF THE DRAWINGS

FIG. 1 is an external perspective view of a robot 1 according to an embodiment of the present invention;

FIG. 2 is a block diagram of the internal structure of the robot 1 shown in FIG. 1;

FIG. 3 is a block diagram of the functional structure of a controller 10 shown in FIG. 2;

FIG. 4 is a block diagram of the internal structure of a speech recognition unit 31A;

FIG. 5 is a block diagram of the internal structure of a conversation processor 38;

FIG. 6 is a block diagram of the internal structure of a speech synthesizer 36;

FIGS. 7A and 7B are block diagrams of the system configuration when downloading information n;

FIG. 8 is a block diagram showing the structure of the system shown in FIGS. 7A and 7B in detail;

FIG. 9 is a block diagram of another detailed structure of the system shown in FIGS. 7A and 7B;

FIG. 10 shows the timing for changing the topic;

FIG. 11 shows the timing for changing the topic;

FIG. 12 shows the timing for changing the topic;

FIG. 13 shows the timing for changing the topic;

FIG. 14 is a flowchart showing the timing for changing the topic;

FIG. 15 is a graph showing the relationship between an average and a probability for determining the timing for changing the topic;

FIGS. 16A and 16B show speech patterns;

FIG. 17 is a graph showing the relationship between pausing time in a conversation and a probability for determining the timing for changing the topic;

FIG. 18 shows information stored in a topic memory 76;

FIG. 19 shows attributes, which are keywords in the present embodiment;

FIG. 20 is a flowchart showing a process for changing the topic;

FIG. 21 is a table showing degrees of association;

FIG. 22 is a flowchart showing the details of step S15 of the flowchart shown in FIG. 20;

FIG. 23 is another flowchart showing a process for changing the topic;

FIG. 24 shows an example of a conversation between a robot 1 and a user;

FIG. 25 is a flowchart showing a process performed by the robot 1 in response to the topic change by the user;

FIG. 26 is a flowchart showing a process for updating the degree of association table;

FIG. 27 is a flowchart showing a process performed by the conversation processor 38;

FIG. 28 shows attributes;

FIG. 29 shows an example of a conversation between the robot 1 and the user; and

FIG. 30 shows data storage media.

### DESCRIPTION OF THE PREFERRED EMBODIMENTS

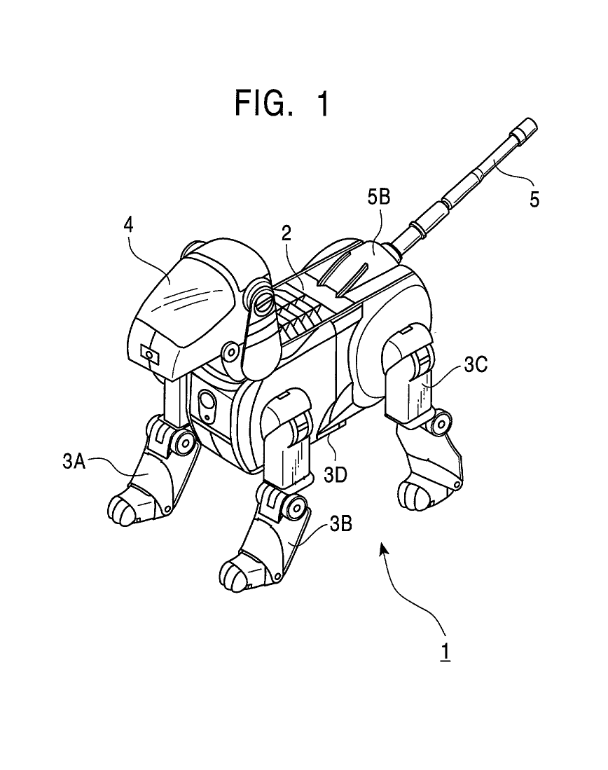

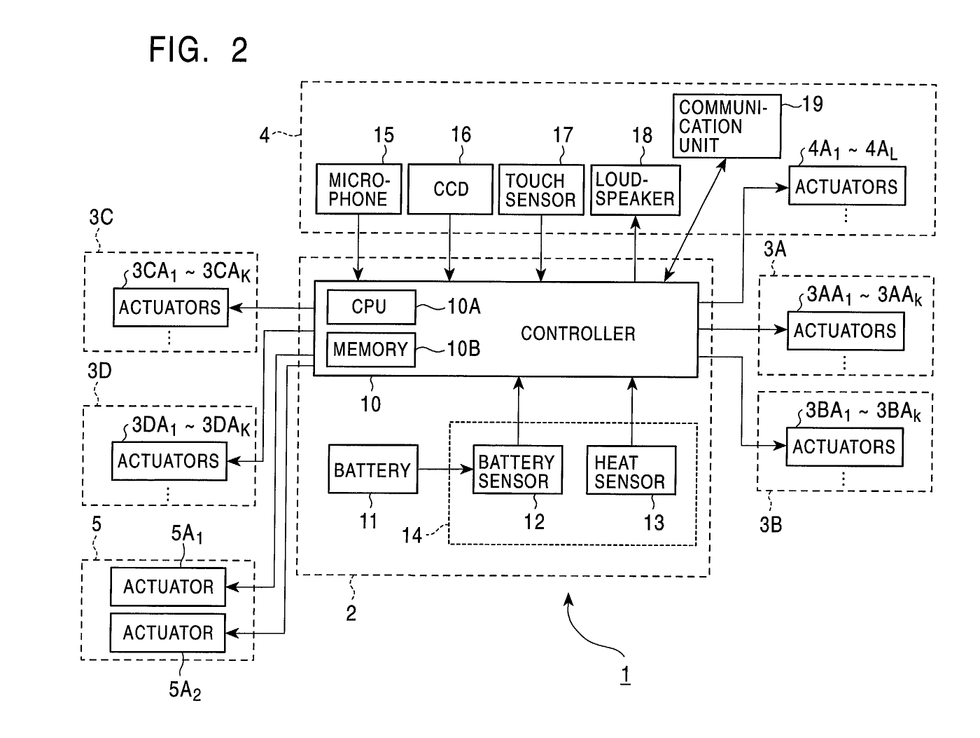

FIG. 1 shows an external view of a robot 1 according to an embodiment of the present invention. FIG. 2 shows the electrical configuration of the robot 1.

In the present embodiment, the robot 1 has the form of a dog. A body unit 2 of the robot 1 includes leg units 3A, 3B, 3C, and 3D connected thereto to form forelegs and hind legs. The body unit 2 also includes a head unit 4 and a tail unit 5 connected thereto at the front and at the rear, respectively.

The tail unit 5 is extended from a base unit 5B provided on the top of the body unit 2, and the tail unit 5 is extended so as to bend or swing with two degree of freedom. The body unit 2 includes therein a controller 10 for controlling the overall robot 1, a battery 11 as a power source of the robot 1, and an internal sensor unit 14 including a battery sensor 12 and a heat sensor 13.

The head unit 4 is provided with a microphone 15 that corresponds to “ears”, a charge coupled device (CCD) camera 16 that corresponds to “eyes”, a touch sensor 17 that corresponds to touch receptors, and a loudspeaker 18 that corresponds to a “mouth”, at respective predetermined locations.

As shown in FIG. 2, the joints of the leg units 3A to 3D, the joints between each of the leg units 3A to 3D and the body unit 2, the joint between the head unit 4 and the body unit 2, and the joint between the tail unit 5 and the body unit 2 are provided with actuators 3AA₁ to 3AA_{K}, 3BA₁ to 3BA_{K}, 3CA₁ to 3CA_{K}, 3DA₁ to 3DA_{K}, 4A₁ to 4A_{L}, 5A₁, and 5A₂, respectively. Therefore, the joints are movable with predetermined degrees of freedom.

The microphone 15 of the head unit 4 collects ambient speech (sounds) including the speech of a user and sends the obtained speech signals to the controller 10. The CCD camera 16 captures an image of the surrounding environment and sends the obtained image signal to the controller 10.

The touch sensor 17 is provided on, for example, the top of the head unit 4. The touch sensor 17 detects pressure applied by a physical contact, such as “patting” or “hitting” by the user, and sends the detection result as a pressure detection signal to the controller 10.

The battery sensor 12 of the body unit 2 detects the power remaining in the battery 11 and sends the detection result as a battery remaining power detection signal to the controller 10. The heat sensor 13 detects heat in the robot 1 and sends the detection result as a heat detection signal to the controller 10.

The controller 10 includes therein a central processing unit (CPU) 10A, a memory 10B, and the like. The CPU 10A executes a control program stored in the memory 10B to perform various processes. Specifically, the controller 10 determines the characteristics of the environment, whether a command has been given by the user, or whether the user has approached, based on the speech signal, the image signal, the pressure detection signal, the battery remaining power detection signal, and the heat detection signal, supplied from the microphone 15, the CCD camera 16, the touch sensor 17, the battery sensor 12, and the heat sensor 13, respectively.

Based on the determination result, the controller 10 determines subsequent actions to be taken. Based on the determination result for determining the subsequent actions to be taken, the controller 10 activates necessary units among the actuators 3AA₁ to 3AA_{K}, 3BA₁ to 3BA_{K}, 3CA₁ to 3CA_{K}, 3DA₁ to 3DA_{K}, 4A₁ to 4A_{L}, 5A₁, and 5A₂. This causes the head unit 4 to sway vertically and horizontally, causes the tail unit 5 to move, and activates the leg units 3A to 3D to cause the robot 1 to walk.

As circumstances demand, the controller 10 generates a synthesized sound and supplies the generated sound to the loudspeaker 18 to output the sound. In addition, the controller 10 causes a light emitting diode (LED) (not shown) provided at the position of the “eyes” of the robot 1 to turn on, turn off, or flash on and off.

Accordingly, the robot 1 is configured to behave autonomously based on the surrounding conditions.

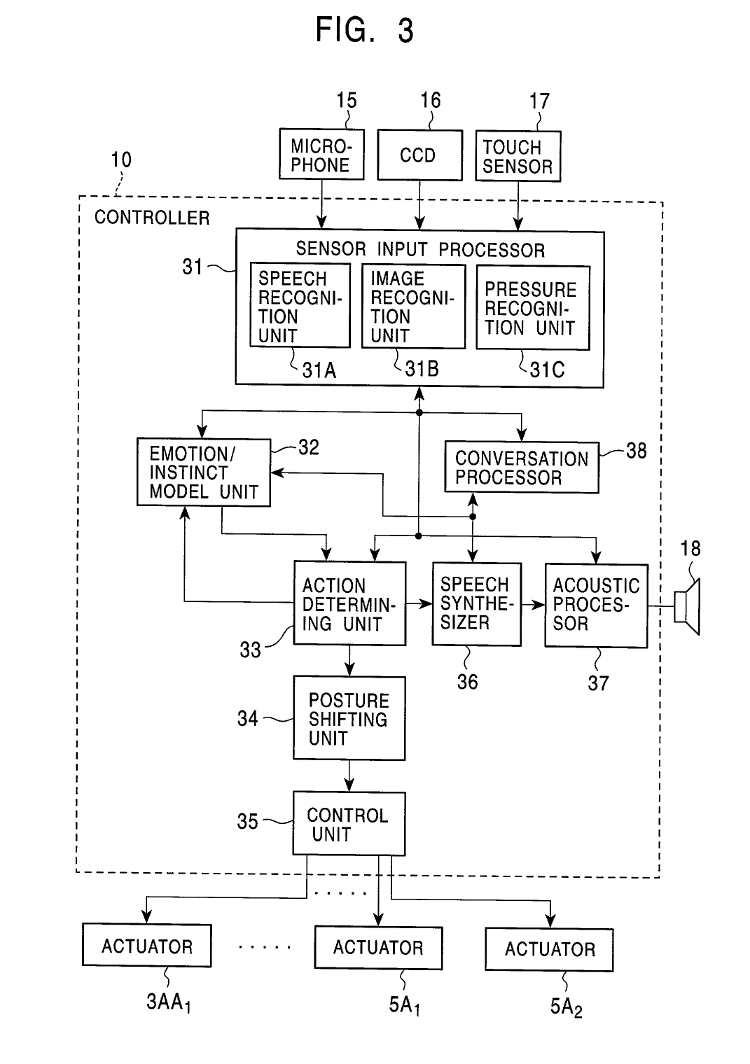

FIG. 3 shows the functional structure of the controller 10 shown in FIG. 2. The function structure shown in FIG. 3 is implemented by the CPU 10A executing the control program stored in the memory 10B.

The controller 10 includes a sensor input processor 31 for recognizing a specific external condition; an emotion/instinct model unit 32 for expressing emotional and instinctual states by accumulating the recognition result obtained by the sensor input processor 31 and the like; an action determining unit 33 for determining subsequent actions based on the recognition result obtained by the sensor input processor 31 and the like; a posture shifting unit 34 for causing the robot 1 to actually perform an action based on the determination result obtained by the action determining unit 33; a control unit 35 for driving and controlling the actuators 3AA₁ to 5A₁ and 5A₂; a speech synthesizer 36 for generating a synthesized sound; and an acoustic processor 37 for controlling the sound output by the speech synthesizer 36.

The sensor input processor 31 recognizes a specific external condition, a specific approach made by the user, and a command given by the user based on the speech signal, the image signal, the pressure detection signal, and the like supplied from the microphone 15, the CCD camera 16, the touch sensor 17, and the like, and informs the emotion/instinct model unit 32 and the action determining unit 33 of state recognition information indicating the recognition result.

Specifically, the sensor input processor 31 includes a speech recognition unit 31A. Under the control of the action determining unit 33, the speech recognition unit 31A performs speech recognition by using the speech signal supplied from the microphone 15. The speech recognition unit 31A informs the emotion/instinct model unit 32 and the action determining unit 33 of the speech recognition result, which is a command, such as “walk”, “lie down”, or “chase the ball”, or the like, as the state recognition information.

The speech recognition unit 31A outputs the recognition result obtained by performing speech recognition to a conversation processor 38, enabling the robot 1 to hold a conversation with a user. This is described hereinafter.

The sensor input processor 31 includes an image recognition unit 31B. The image recognition unit 31B performs image recognition processing by using the image signal supplied from the CCD camera 16. When the image recognition unit 31B resultantly detects, for example, “a red, round object” or “a plane perpendicular to the ground of a predetermined height or greater”, the image recognition unit 31B informs the emotion/instinct model unit 32 and the action determining unit 33 of the image recognition result such that “there is a ball” or “there is a wall” as the state recognition information.

Furthermore, the sensor input processor 31 includes a pressure processor 31C. The pressure processor 31C processes the pressure detection signal supplied from the touch sensor 17. When the pressure processor 31C resultantly detects pressure that exceeds a predetermined threshold and that is applied in a short period of time, the pressure processor 31C recognizes that the robot 1 has been “hit (punished)”. When the pressure processor 31C detects pressure that falls below a predetermined threshold and that is applied over a long period of time, the pressure processor 31C recognizes that the robot 1 has been “patted (rewarded)”. The pressure processor 31C informs the emotion/instinct model unit 32 and the action determining unit 33 of the recognition result as the state recognition information.

The emotion/instinct model unit 32 manages an emotion model for expressing emotional states of the robot 1 and an instinct model for expressing instinctual states of the robot 1. The action determining unit 33 determines the subsequent action based on the state recognition information supplied from the sensor input processor 31, the emotional/instinctual state information supplied from the emotion/instinct model unit 32, the elapsed time, and the like, and sends the content of the determined action as action command information to the posture shifting unit 34.

Based on the action command information supplied from the action determining unit 33, the posture shifting unit 34 generates posture shifting information for causing the robot 1 to shift from the present posture to the subsequent posture and outputs the posture shifting information to the control unit 35. The control unit 35 generates control signals for driving the actuators 3AA₁ to 5A₁ and 5A₂ in accordance with the posture shifting information supplied from the posture shifting unit 34 and sends the control signals to the actuators 3AA₁ to 5A₁ to 5A₂. Therefore, the actuators 3AA₁ to 5A₁ and 5A₂ are driven in accordance with the control signals, and hence, the robot 1 autonomously executes the action.

With the above structure, the robot 1 is operated and is caused to hold a conversation with the user. A speech conversation system for carrying out a conversation includes the speech recognition unit 31A, the conversation processor 38, the speech synthesizer 36, and the acoustic processor 37.

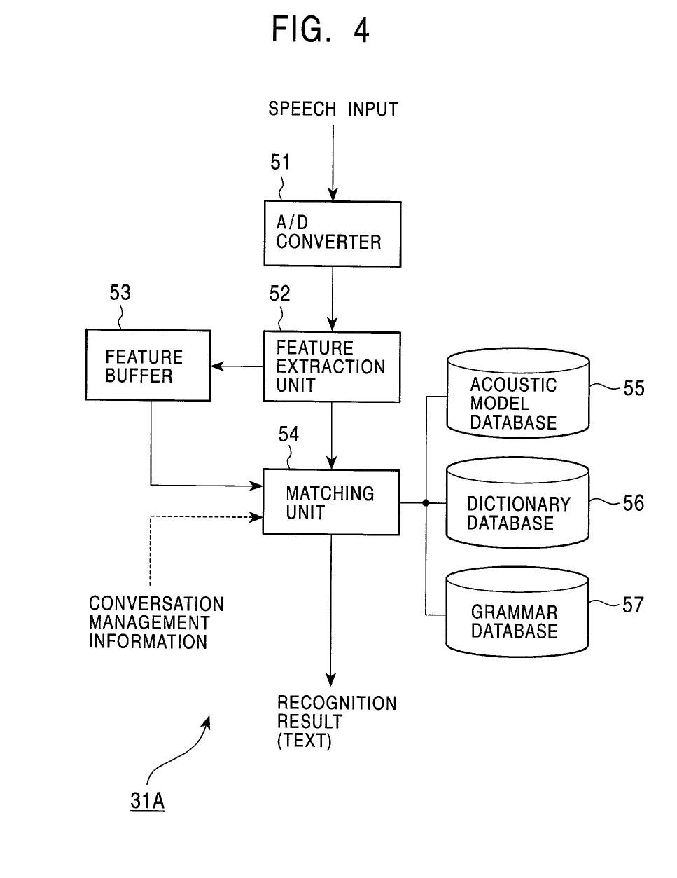

FIG. 4 shows the detailed structure of the speech recognition unit 31A. User's speech is input to the microphone 15, and the microphone 15 converts the speech into a speech signal as an electrical signal. The speech signal is supplied to an analog-to-digital (A/D) converter 51 of the speech recognition unit 31A. The A/D converter 51 samples the speech signal, which is an analog signal supplied from the microphone 15, and quantizes the sampled speech signal, thereby converting the signal into speech data, which is a digital signal. The speech data is supplied to a feature extraction unit 52.

Based on the speech data supplied from the A/D converter 51, the feature extraction unit 52 extracts feature parameters such as a spectrum, a linear prediction coefficient, a cepstrum coefficient, a line spectrum pair, and the like for each of appropriate frames. The feature extraction unit 52 supplies the extracted feature parameters to a feature buffer 53 and a matching unit 54. The feature buffer 53 temporarily stores the feature parameters supplied from the feature extraction unit 52.

Based on the feature parameters supplied from the feature extraction unit 52 or the feature parameters stored in the feature buffer 53, the matching unit 54 recognizes the speech (input speech) input via the microphone 15 by referring to an acoustic model database 55, a dictionary database 56, and a grammar database 57 as circumstances demand.

Specifically, the acoustic model database 55 stores an acoustic model showing acoustic features of each phoneme or syllable in the language of speech to be recognized. For example, the Hidden Markov Model (HMM) can be used as the acoustic model. The dictionary database 56 stores a word dictionary that contains information concerning the pronunciation of each word to be recognized. The grammar database 57 stores grammar rules describing how words registered in the word dictionary of the dictionary database 56 are linked and concatenated. For example, context-free grammar (CFG) or a rule based on statistical word concatenation probability (N-gram) can be used as the grammar rule.

The matching unit 54 refers to the word dictionary of the dictionary database 56 to connect the acoustic models stored in the acoustic model database 55, thus forming the acoustic model (word model) for a word. The matching unit 54 also refers to the grammar rule stored in the grammar database 57 to connect word models and uses the connected word models to recognize speech input via the microphone 15 based on the feature parameters by using, for example, the HMM method or the like. The speech recognition result obtained by the matching unit 54 is output in the form of, for example, text.

The matching unit 54 can receive information obtained by the conversation processor 38 from the conversation processor 38. The matching unit 54 can perform highly accurate speech recognition based on the conversation management information. When it is necessary to again process the input speech, the matching unit 54 uses the feature parameters stored in the feature buffer 53 and processes the input speech. Therefore, it is not necessary to again request the user to input speech.

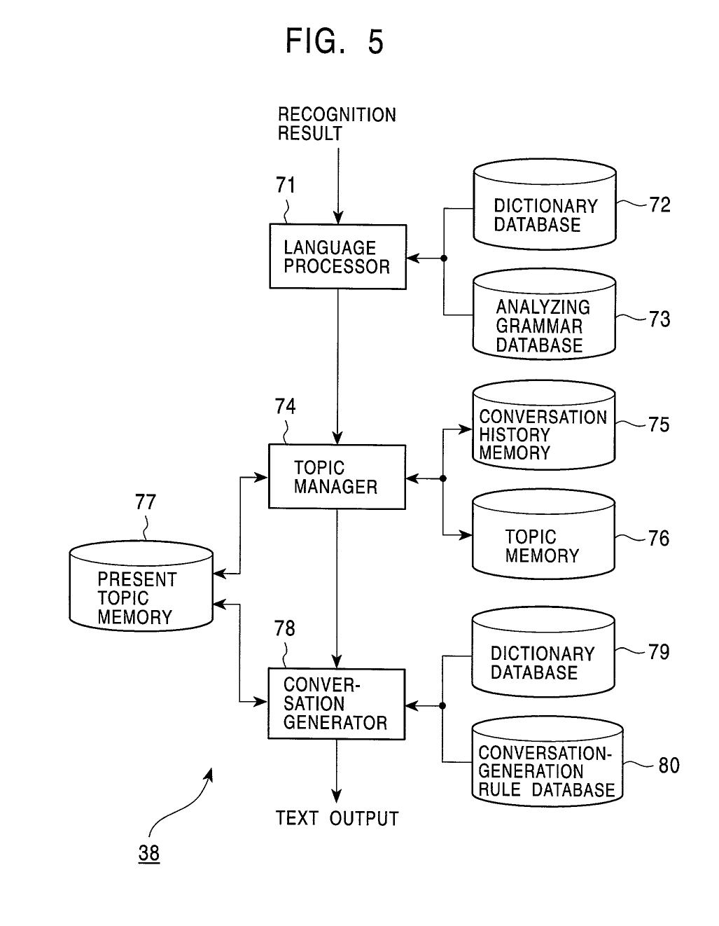

FIG. 5 shows the detailed structure of the conversation processor 38. The recognition result (text data) output from the speech recognition unit 31A is input to a language processor 71 of the conversation processor 38. Based on data stored in a dictionary database 72 and an analyzing grammar database 73, the language processor 71 analyzes the input speech recognition result by performing morphological analysis and parsing syntactic analysis and extracts language information such as word information and syntax information. Based on the content of the dictionary, the language processor 71 also extracts the meaning and the intention of the input speech.

Specifically, the dictionary database 72 stores information required to apply word notation and analyzing grammar, such as information on parts of speech, semantic information on each word, and the like. The analyzing grammar database 73 stores data describing restrictions concerning word concatenation based on the information on each word stored in the dictionary database 72. Using these data, the language processor 71 analyzes the text data, which is the speech recognition result of the input speech.

The data stored in the analyzing grammar database 73 are required to perform text analysis using regular grammar, context-free grammar, N-gram, and, when further performing semantic analysis, language theories including semantics such as head-driven phrase structure grammar (HPSG).

Based on the information extracted by the language processor 71, a topic manager 74 manages and updates the present topic in a present topic memory 77. In preparation for the subsequent change of topic, which will be described in detail below, the topic manager 74 appropriately updates information under management of a conversation history memory 75. When changing the topic, the topic manager 74 refers to information stored in a topic memory 76 and determines the subsequent topic.

The conversation history memory 75 accumulates the content of conversation or information extracted from conversation. The conversation history memory 75 also stores data used to examine topics which were brought up prior to the present topic, which is stored in the present topic memory 77, and to control the change of topic.

The topic memory 76 stores a plurality of pieces of information for maintaining the consistency of the content of conversation between the robot 1 and a user. The topic memory 76 accumulates information referred to when the topic manager 74 searches for the subsequent topic when changing the topic or when the topic is to be changed in response to the change of topic introduced by the user. The information stored in the topic memory 76 is added and updated by a process described below.

The present topic memory 77 stores information concerning the present topic being discussed. Specifically, the present topic memory 77 stores one of the pieces of information on the topics stored in the topic memory 76, which is selected by the topic manager 74. Based on the information stored in the present topic memory 77, the topic manager 74 advances a conversation with the user. The topic manager 74 tracks which content has already been discussed based on information communicated in the conversation, and the information in the present topic memory 77 is appropriately updated.

A conversation generator 78 generates an appropriate response statement (text data) by referring to data stored in a dictionary database 79 and a conversation-generation rule database 80 based on the information concerning the present topic under management of the present topic memory 77, information extracted from the preceding speech of the user by the language processor 71, and the like.

The dictionary database 79 stores word information required to create a response statement. The dictionary database 72 and the dictionary database 79 may store the same information. Hence, the dictionary databases 72 and 79 can be combined as a common database.

The conversation-generation rule database 80 stores rules concerning how to generate each of the response statements based on the content of the present topic memory 77. When a certain topic, in addition to the manner of advancing the conversation with regard to the topic, such as to talk about content that has not yet been discussed or to respond at the beginning, is managed by semantic frame structure or the like, rules to generate natural language statements based on frame structure are also stored. A method of generating a natural language statement based on semantic structure can be performed by the processing performed by the language processor 71 in the reverse order.

Accordingly, the response statement as text data generated by the conversation generator 78 is output to the speech synthesizer 36.

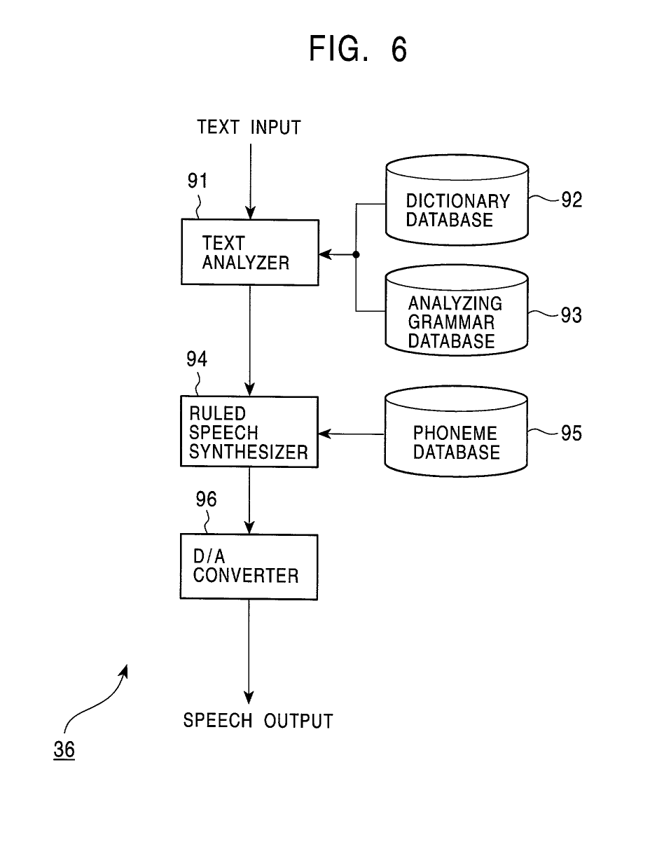

FIG. 6 shows an example of the structure of the speech synthesizer 36. The text output from the conversation processor 38 is input to a text analyzer 91, which is to be used to perform speech synthesis. The text analyzer 91 refers to a dictionary database 92 and an analyzing grammar database 93 to analyze the text.

Specifically, the dictionary database 92 stores a word dictionary including parts-of-speech information, pronunciation information, and accent information on each word. The analyzing grammar database 93 stores analyzing grammar rules, such as restrictions on word concatenation, about each word included in the word dictionary of the dictionary database 92. Based on the word dictionary and the analyzing grammar rules, the text analyzer 91 performs morphological analysis and parsing syntactic analysis of the input text. The text analyzer 91 extracts information necessary for rule-based speech synthesis performed by a ruled speech synthesizer 94 at the subsequent stage. The information necessary for rule-based speech synthesis includes, for example, information for controlling where a pause, accent, and intonation, other prosodic information, and phonemic information should occur, such as the pronunciation of each word.

The information obtained by the text analyzer 91 is supplied to the ruled speech synthesizer 94. The ruled speech synthesizer 94 uses a phoneme database 95 to generate speech data (digital data) for a synthesized sound corresponding to the text input to the text analyzer 91.

Specifically, the phoneme database 95 stores phoneme data in the form of CV (consonant, vowel), VCV, CVC, and the like. Based on the information from the text analyzer 91, the ruled speech synthesizer 94 connects necessary phoneme data and appropriately adds pause, accent, and intonation, thereby generating the speech data for the synthesized sound corresponding to the text input to the text analyzer 91.

The speech data is supplied to a digital-to-analog (D/A) converter 96 to be converted to an analog speech signal. The speech signal is supplied to a loudspeaker (not shown), and hence the synthesized sound corresponding to the text input to the text analyzer 91 is output.

The speech conversation system has the above-described arrangement. Being provided with the speech conversation system, the robot 1 can hold a conversation with a user. When a person is having a conversation with another person, it is not common for them to continue to discuss only one topic. In general, people change the topic at an appropriate point. When changing the topic, there are cases in which people change the topic to a topic that has no relevance to the present topic. It is more usual for people to change the topic to a topic associated with the present topic. This applies to conversations between a person (user) and the robot 1.

The robot 1 has a function for changing the topic at an appropriate circumstance when having a conversation with a user. To this end, it is necessary to store information to be used as topics. The information to be used as topics include not only information known to the user so as to have a suitable conversation with the user, but also information unknown to the user so as to introduce the user to new topics. It is thus necessary to store not only old information but also to store new information.

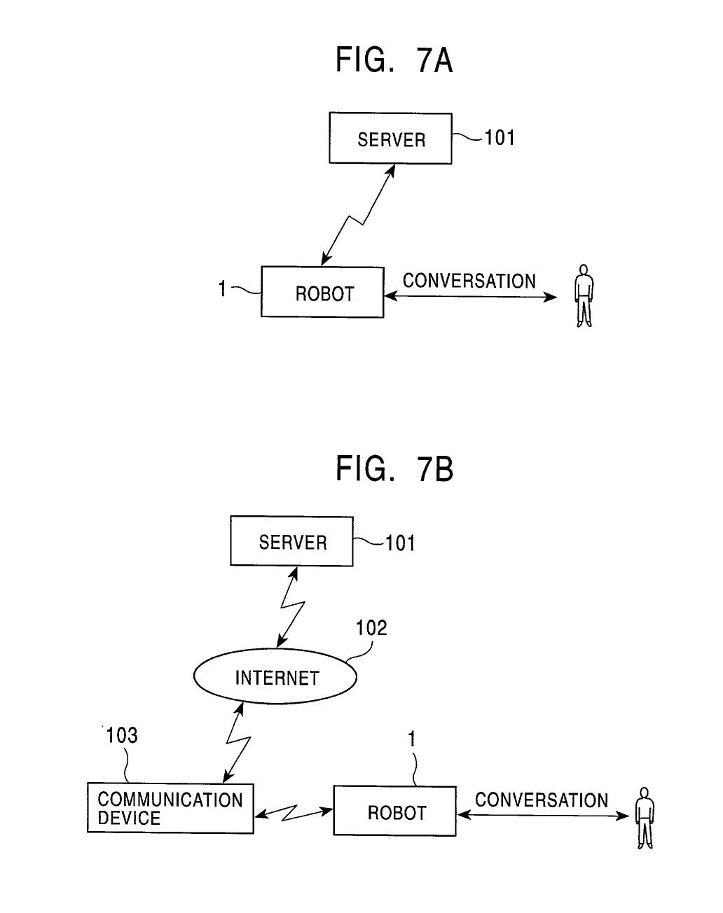

The robot 1 is provided with a communication function (a communication unit 19 shown in FIG. 2) to obtain new information (hereinafter referred to as “information n”). A case in which information n is to be downloaded from a server for supplying the information n is described. FIG. 7A shows a case in which the communication unit 19 of the robot 1 directly communicates with a server 101. FIG. 7B shows a case in which the communication unit 19 and the server 101 communicate with each other via, for example, the Internet 102 as a communication network.

With the arrangement shown in FIG. 7A, the communication unit 19 of the robot 1 can be implemented by employing technology used in the Personal Handyphone System (PHS). For example, while the robot 1 is being charged, the communication unit 19 dials the server 101 to establish a link with the server 101 and downloads the information n.

With the arrangement shown in FIG. 7B, a communication device 103 and the robot 1 communicate with each other by wire or wirelessly. For example, the communication device 103 is formed of a personal computer. A user establishes a link between the personal computer and the server 101 via the Internet 102. The information n is downloaded from the server 101, and the downloaded information n is temporarily stored in a storage device of the personal computer. The stored information n is transmitted to the communication unit 19 of the robot 1 wirelessly by infrared rays or by wire such as by a Universal Serial Bus (USB). Accordingly, the robot 1 obtains the information n.

Alternatively, the communication device 103 automatically establishes a link with the server 101, downloads the information n, and transmits the information n to the robot 1 within a predetermined period of time.

The information n to be downloaded is described next. Although the same information n can be supplied to all users, the information n may not be useful for all the users. In other words, preferences vary depending on the user. In order to carry out a conversation with the user, the information n that agrees with the user's preferences is downloaded and stored. Alternatively, all pieces of information n are downloaded, and only the information n that agrees with the user's preferences is selected and is stored.

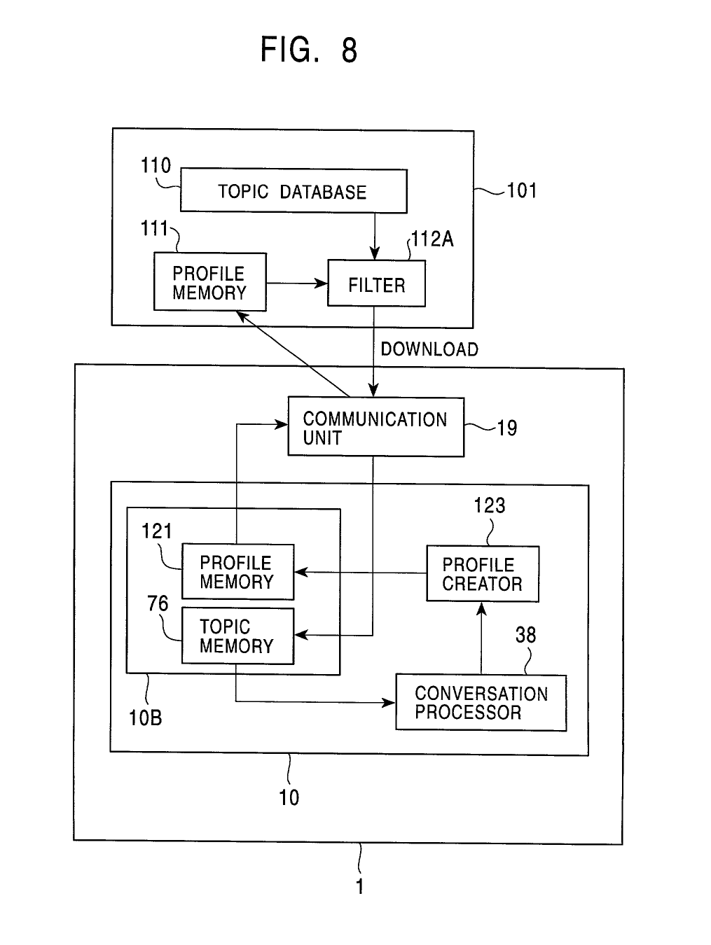

FIG. 8 shows the system configuration for selecting, by the server 101, the information n to be supplied to the robot 1. The server 101 includes a topic database 101, a profile memory 111, and a filter 112A. The topic database 110 stores the information n. The information n is stored according to the categories, such as entertainment information, economic information, and the like. The robot 1 uses the information n to introduce the user to new topics, thus supplying information unknown to the user, which produces advertising effects. Providers including companies that want to perform advertising supply the information n that will be stored in the topic database 110.

The profile memory 111 stores information such as the user's preferences. A profile is supplied from the robot 1 and is appropriately updated. Alternatively, when the robot 1 had numerous conversations with the user, a profile can be created by storing topics (keywords) that appear repeatedly. Also, the user can input a profile to the robot 1, and the robot 1 stores the profile. Alternatively, the robot 1 can ask the user questions in the course of conversations, and a profile is created based on the user's answers to the questions.

Based on the profile stored in the profile memory 111, the filter 112A selects and outputs the information n that agrees with the profile, that is, the user's preferences, from the information n stored in the topic database 110.

The information n output from the filter 112A is received by the communication unit 19 of the robot 1 using the method described with reference to FIGS. 7A and 7B. The information n received by the communication unit 19 is stored in the topic memory 76 in the memory 10B. The information n stored in the topic memory 76 is used when changing the topic.

The information processed and output by the conversation processor 38 is appropriately output to a profile creator 123. As described above, when a profile is created while the robot 1 has a conversation with the user, the profile creator 123 creates the profile, and the created profile is stored in a profile memory 121. The profile stored in the profile memory 121 is appropriately transmitted to the profile memory 111 of the server 101 via the communication unit 19. Hence, the profile in the profile memory 111 corresponding to the user of the robot 1 is updated.

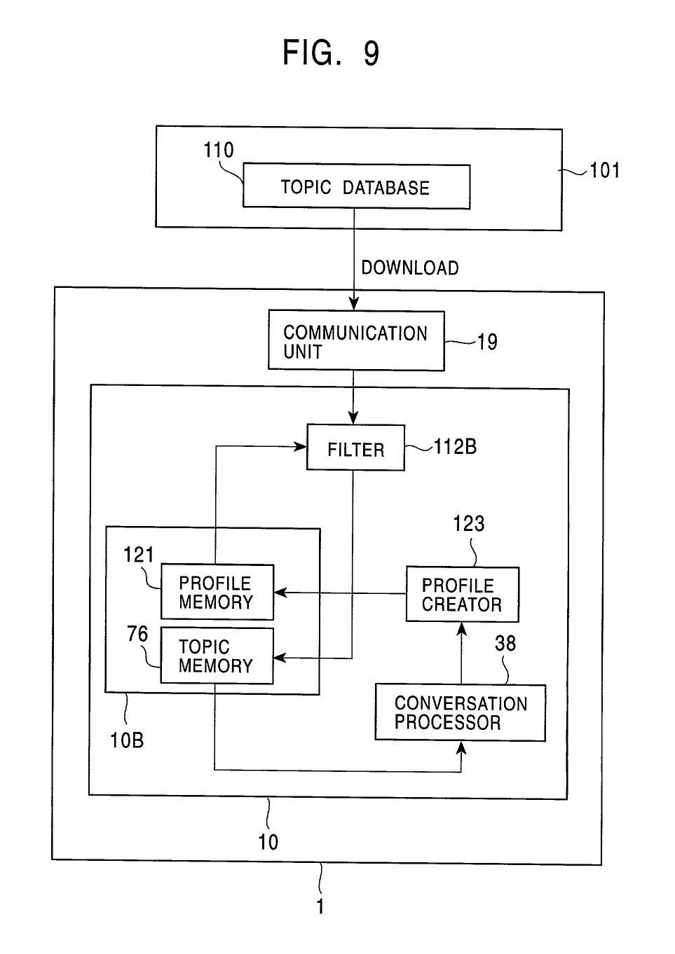

With the arrangement shown in FIG. 8, the profile (user information) stored in the profile memory 111 may be leaked to the outside. In view of privacy protection, a problem may occur. In order to protect the user's privacy, the server 101 can be configured so as not to manage the profile. FIG. 9 shows the system configuration when the server 101 does not manage the profile.

In the arrangement shown in FIG. 9, the server 101 includes only the topic database 110. The controller 10 of the robot 1 includes a filter 112B. With this arrangement, the server 101 provides the robot 1 with the entirety of the information n stored in the topic database 110. The information n received by the communication unit 19 of the robot 1 is filtered by the filter 112B, and only the resultant information n is stored in the topic memory 76.

When the robot 1 is configured to select the information n, the user's profile is not transmitted to the outside, and hence it is not externally managed. The user's privacy is therefore protected.

The information used as the profile is described next. The profile information includes, for example, age, sex, birthplace, favorite actor, favorite place, favorite food, hobby, and nearest mass transit station. Also, numerical information indicating the degree of interest in economic information, entertainment information, and sports information is included in the profile information.

Based on the above-described profile, the information n that agrees with the user's preferences is selected and is stored in the topic memory 76. Based on the information n stored in the topic memory 76, the robot 1 changes the topic so that the conversation with the user continues naturally and fluently. To this end, the timing of the changing of the topic is also important. The manner for determining the timing for changing the topic is described next.

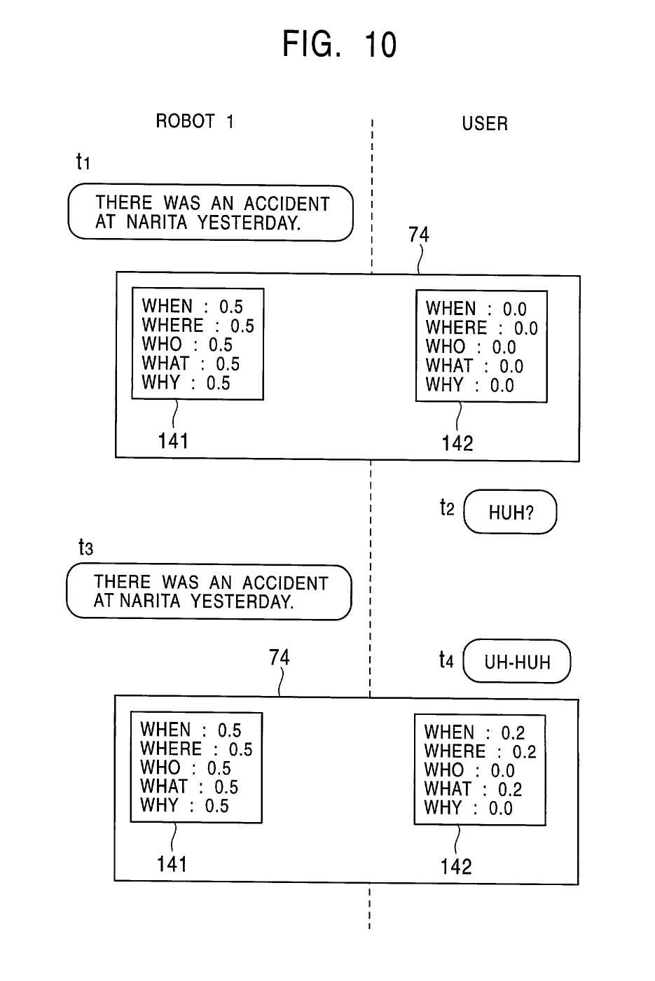

In order to change the topic, when the robot 1 begins a conversation with the user, the robot 1 creates a frame for itself (hereinafter referred to as a “robot frame”) and another frame for the user (hereinafter referred to as a “user frame”). Referring to FIG. 10, the frames are described. “There was an accident at Narita yesterday,” the robot 1 introduces a new topic to the user at time t₁. At this time, a robot frame 141 and a user frame 142 are created in the topic manager 74.

The robot frame 141 and the user frame 142 are provided with the same items, that is, five items including “when”, “where”, “who”, “what”, and “why”. When the robot 1 introduces the topic that “There was an accident at Narita yesterday”, each item in the robot frame 141 is set to 0.5. The value that can be set for each item ranges from 0.0 to 1.0. When a certain item is set to 0.0, it indicates that the user knows nothing about that item (the user has not previously discussed that item). When a certain item is set to 1.0, it indicates that the user is familiar with the entirety of the information (the user has fully discussed that item).

When the robot 1 introduces a topic, it is indicated that the robot 1 has information about that topic. In other words, the introduced topic is stored in the topic memory 76. Specifically, the introduced topic had been stored in the topic memory 76. Since the introduced topic becomes the present topic, the introduced topic is transferred from the topic memory 76 to the present memory 77, and hence the introduced topic is now stored in the present memory 77.

The user may or may not possess more information concerning the stored information. When the robot 1 introduces a topic, the initial value of each item in the robot frame 141 concerning the introduced topic is set to 0.5. It is assumed that the user knows nothing about the introduced topic, and each item in the user frame 142 is set to 0.0.

Although the initial value of 0.5 is set in the present embodiment, it is possible to set another value as the initial value. Specifically, the item “when” generally includes five pieces of information, that is, “year”, “month”, “date”, “hour”, and “minute”. (If “second” information is included in the item “when”, a total of six pieces of information are included. Since a conversation does not generally reach the level of “second”, “second” information is not included in the item “when”.) If five pieces of information are included, it is possible to determine that the entirety of the information is provided. Therefore, 1.0 divided by 5 is 0.2, and 0.2 can be assigned to each piece of information. For example, it is possible to conclude that the word “yesterday” includes three pieces of information, that is, “year”, “month”, and “date”. Hence, 0.6 is set for the item “when”.

In the above description, the initial value of each item is set to 0.5. When a keyword that corresponds to, for example, the item “when” is not included in the present topic, it is possible to set 0.0 as the initial value of the topic “when” in the topic memory 76.

When the conversation begins in this manner, the robot frame 141, the user frame 142, and the value of each item on the frames 141 and 142 are set. In response to the oral statement “There was an accident at Narita yesterday” made by the robot 1, the user says at time t₂, “Huh?”, so as to ask the robot 1 to repeat what the robot 1 has said. At time t₃, the robot 1 repeats the same oral statement.

Since the oral statement is repeated, the user understands the oral statement made by the robot 1, and the user says at time t₄, “Uh-huh”, expressing that the user has understood the oral statement made by the robot 1. In response to this, the user frame 142 is rewritten. At the user side, it is determined that the items “when”, “where”, and “what” become known respectively based on the information indicating “yesterday”, “at Narita”, and “there was an accident”. These items are set to 0.2.

Although these items are set to 0.2 in the present embodiment, they can be set to another value. For example, concerning the item “when” on the present topic, when the robot 1 has conveyed all the information that the robot 1 possesses, the item “when” in the user frame 142 can be set to the same value as that in the robot frame 141. Specifically, when the robot 1 only possesses the keyword “yesterday” for the item “when”, the robot 1 has already given that information to the user. The value of the item “when” in the user frame 142 is set to 0.5, which is the same as that set for the item “when” in the robot frame 141.

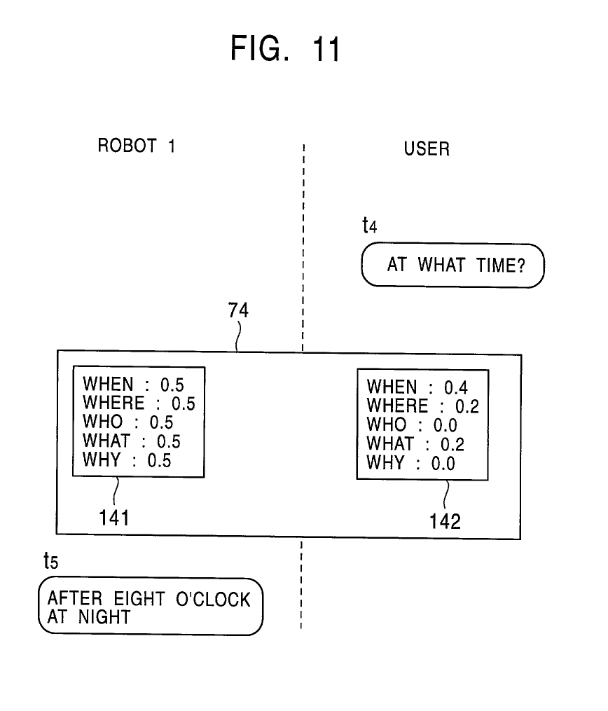

Referring to FIG. 11, the user asks the robot 1 at time t₄, “At what time?”, instead of saying “Uh-huh”. In this case, different values are set for the user frame 142. Specifically, since the user asks the robot 1 the question concerning the item “when”, the robot 1 determines that the user is interested in the information on the item “when”. The robot 1 then sets the item “when” in the user frame 142 to 0.4, which is larger than 0.2 set for the other items. Accordingly, the values set for the items in the robot frame 141 and the user frame 142 vary according to the content of the conversation.

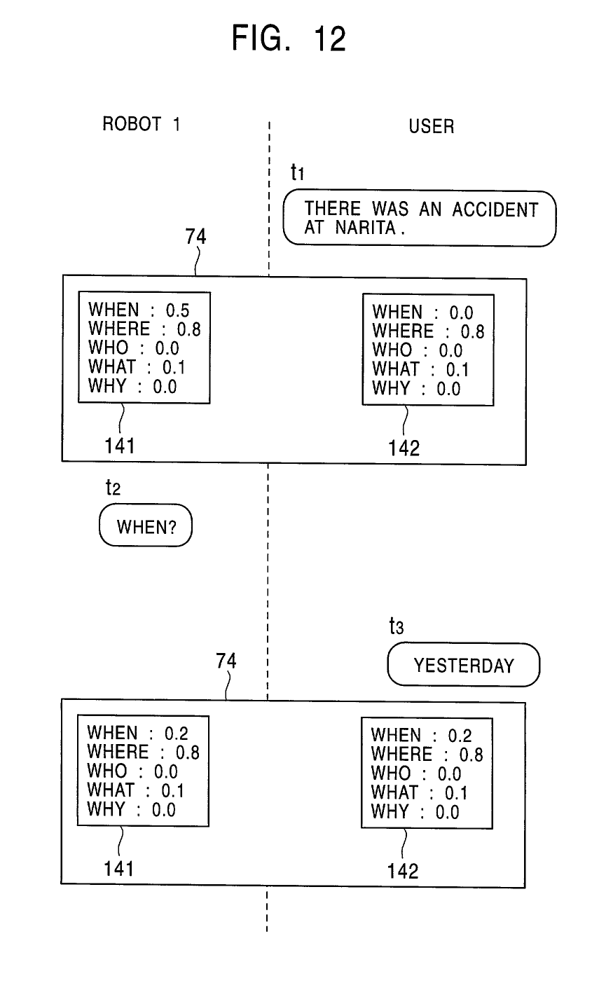

In the above description, the robot 1 has introduced the topic to the user. Referring to FIG. 12, a case in which the user introduces the topic to the robot 1 is described. “There was an accident at Narita,” the user says to the robot 1 at time t₁. In response to this, the robot 1 creates the robot frame 141 and the user frame 142.

The values for the items “where” and “what” in the user frame 142 are set respectively based on the information indicating “at Narita” and “there was an accident”. Similarly, each item in the robot frame 141 is set to the same value as that in the user frame 142.

At time t₂, the robot 1 makes a response to the oral statement made by the user. The robot 1 creates a response statement so that the conversation continues in a manner such that the items with the value 0.0 eventually disappear from the robot frame 141 and the user frame 142. In this case, the item “when” in each of the robot frame 141 and the user frame 142 is set to 0.0. “When?” the robot 1 asks the user at time t₂.

In response to the question, the user answers at time t₃, “Yesterday”. In response to this statement, the value of each item in the robot frame 141 and the user frame 142 is reset. Specifically, since the information indicating “yesterday” concerning the item “when” is obtained, the item “when” in each of the robot frame 141 and the user frame 142 is reset from 0.0 to 0.2.

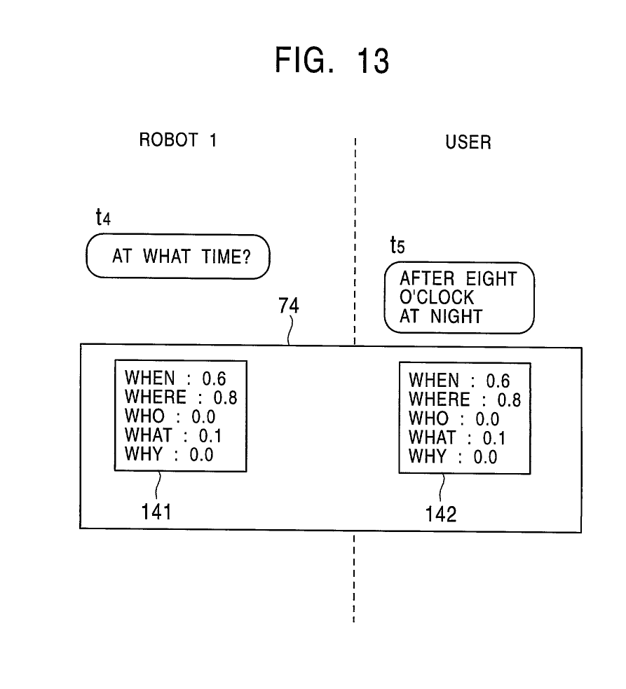

Referring to FIG. 13, the robot 1 asks the user at time t₄, “At what time?”. “After eight o'clock at night,” the user answers to the question at time t₅. The item “when” in each of the robot frame 141 and the user frame 142 is reset to 0.6, which is larger than 0.2. In this manner, the robot 1 asks the questions of the user, and hence the conversation is carried out so that the items set to 0.0 will eventually disappear. Therefore, the robot 1 and the user can have a natural conversation.

Alternatively, the user says at time t₅, “I don't know”. In this case, the item “when” in each of the robot frame 141 and the user frame 142 is set to 0.6, as described above. This is intended to stop the robot 1 from again asking a question about the item that both the robot 1 and the user know nothing about. In other words, when the value is maintained at a small value, the robot 1 may happen to again ask the question of the user. The value is set to a larger value in order to prevent further such occurrences. When the robot 1 receives the response that the user knows nothing about a certain item, it is impossible to continue a conversation about that item. Therefore, such an item can be set to 1.0.

By continuing such a conversation, the value of each item in the robot frame 141 and the user frame 142 approaches 1.0. When all the items on a particular topic are set to 1.0, it means that everything about that topic has been discussed. In such a case, it is natural to change the topic. It is also natural to change the topic prior to having fully discussed the topic. In other words, if the robot 1 is set so that the topic of conversation cannot be changed to the subsequent topic prior to having fully discussed a certain topic, it is assumed that the conversation tends to contain too many questions and fails to amuse the user. Therefore, the robot 1 is set so that the topic may happen to be changed prior to having been fully discussed (i.e., before all the items reach 1.0).

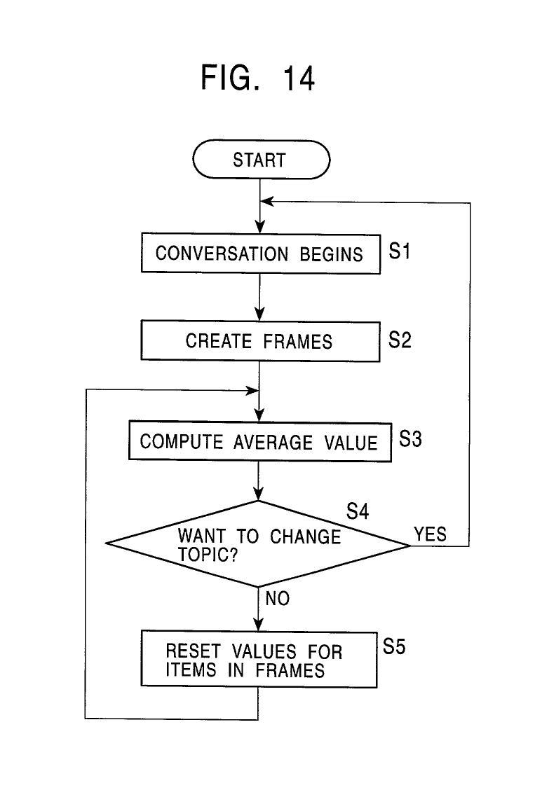

FIG. 14 shows a process for controlling the timing for changing the topic using the frames as described above. In step S1, a conversation about a new topic begins. In step S2, the robot frame 141 and the user frame 142 are generated in the topic manager 74, and the value of each item is set. In step S3, the average is computed. In this case, the average of a total of ten items in the robot frame 141 and the user frame 142 is computed.

After the average is computed, the process determines, in step S4, whether to change the topic. A rule can be made such that the topic is changed if the average exceeds threshold T₁, and the process can determine whether to change the topic in accordance with the rule. If threshold T₁ is set to a small value, topics are frequently changed halfway. In contrast, if threshold T₁ is set to a large value, the conversation tends to contain too many questions. It is assumed that such settings will have undesirable effects.

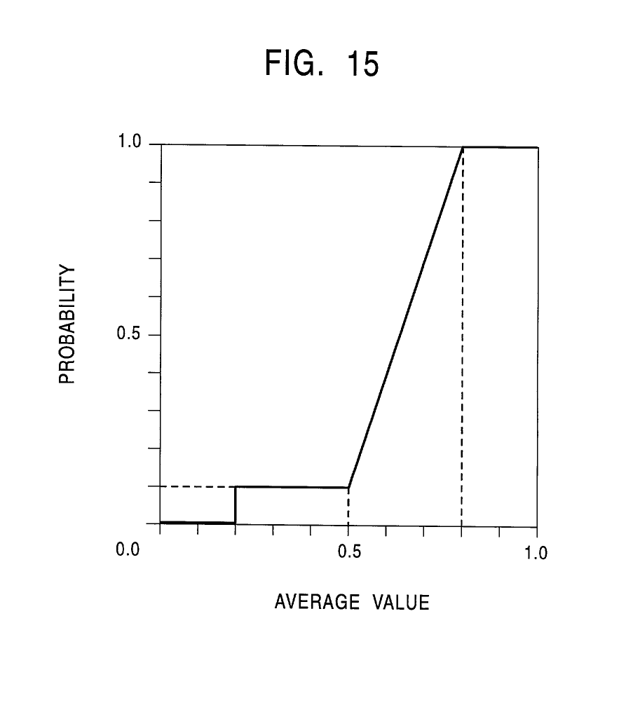

In the present embodiment, a function shown in FIG. 15 is used to change the probability of the topic being changed based on the average. Specifically, when the average is within a range of 0.0 to 0.2, the probability of the topic being changed is 0. Therefore, the topic is not changed. When the average is within a range of 0.2 to 0.5, the topic is changed with a probability of 0.1. When the average is within a range of 0.5 to 0.8, the probability is computed using the equation probability=3×average−1.4. The topic is changed in accordance with the computed probability. When the average is within a range of 0.8 to 1.0, the topic is changed with a probability of 1.0, that is, the topic is always changed.

By using the average and the probability, the timing for changing the topic can be changed. It is therefore possible to make the robot 1 hold a more natural conversation with the user. The function shown in FIG. 15 is used by way of example, and the timing can be changed in accordance with another function. Also, it is possible to make a rule such that, although the probability is not 0.0 when the average is 0.2 or greater, the probability of the topic being changed is set to 0.0 when four out of ten items in the frames are set to 0.0.

Also, it is possible to use different functions depending on the time of day of the conversation. For example, different functions can be used in the morning and at night. In the morning, the user may have a wide-ranging conversation briefly touching on a number of subjects, whereas at night the conversation may be deeper.

Referring back to FIG. 14, if the process determines to change the topic in step S4, the topic is changed (a process for extracting the subsequent topic is described hereinafter), and the process repetitively performs processing from step S1 onward based on the subsequent topic. In contrast, when the process determines not to change the topic in step S4, the process resets the values of the items in the frames in accordance with a new statement. The process repeats processing from step S3 onward using the reset values.

Although the process for determining the timing for changing the topic is performed using the frames, the timing can be determined using a different process. When the robot 1 continues to have exchanges in a conversation with the user, the number of exchanges between the robot 1 and the user can be counted. In general, when there have been a large number of exchanges, it can be concluded that the topic has been fully discussed. It is thus possible to determine whether to change the topic based on the number of exchanges in a conversation.

If N is a count indicating the number of exchanges in a conversation, and if the count N simply exceeds a predetermined threshold, the topic can be changed. Alternatively, a value P obtained by calculating the equation P=1−1/N can be used instead of the average shown in FIG. 15.

Instead of counting the number of exchanges in a conversation, the duration of a conversation can be measured, and the timing for changing the topic can be determined based on the duration. The duration of oral statements made by the robot 1 and the duration of oral statements made by the user are accumulated and added, and the sum T is used instead of the count N. When the sum T exceeds a predetermined threshold, the topic can be changed. Alternatively, Tr indicates the reference conversation time, and a value P obtained by calculating the equation P=T/Tr can be used instead of the average shown in FIG. 15.

When the count N or the sum T is used to determine the timing for changing the topic, the processing to be performed is basically the same as that described with reference to FIG. 14. The only difference is that the processing in step S2 to create the frames is changed to initialize the count N (or the sum T) to zero, that the processing in step S3 is omitted, and that the processing in step S5 is changed to update the count N (or the sum T).

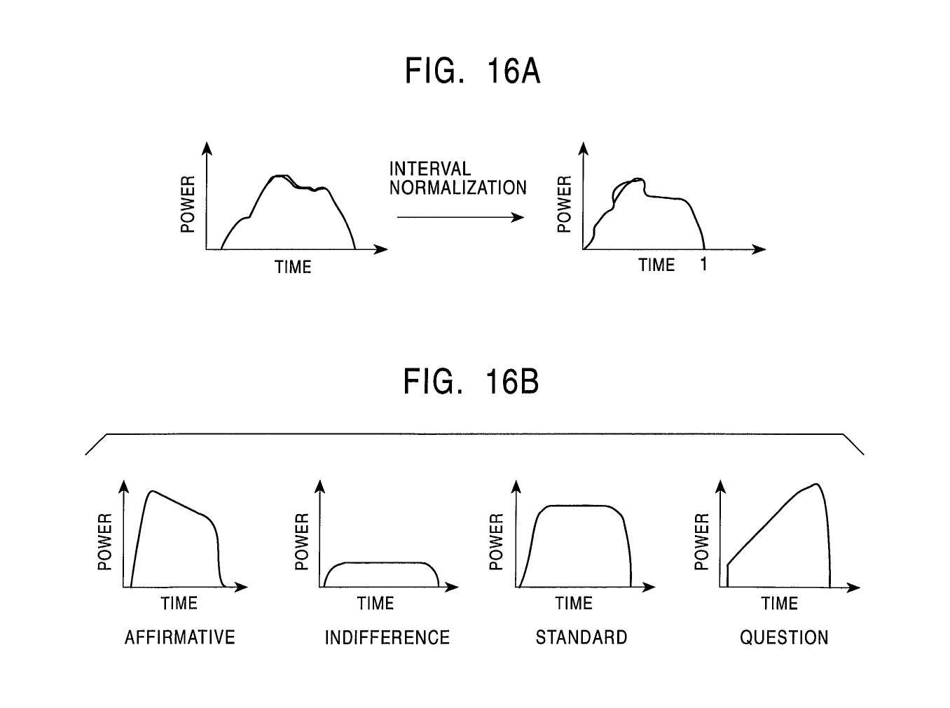

Responding by a person to a conversation partner is an important element in determining whether the person is interested in the content being discussed. If it is determined that the user is not interested in the conversation, it is preferable that the topic be changed. Another process for determining the timing for changing the topic uses time-varying sound pressure of the speech by the user. Referring to FIG. 16A, interval normalization of the user's speech (input pattern) that has been input is performed to analyze the input pattern.

FIG. 16B shows four patterns that can be assumed as the normalized analysis results of the interval normalization of the user's speech (response). Specifically, there are an affirmative pattern, an indifference pattern, a standard pattern (merely responding with no intention), and a question pattern. The pattern to which the result of the interval normalization of the input pattern that has been input is similar is determined by, for example, a process for computing the distance using the inner products as vectors, the inner products being obtained using a few reference functions.

If it is determined that the input pattern that has been input is a pattern showing indifference, the topic can be immediately changed. Alternatively, the number of determinations that the input pattern show indifference can be accumulated, and, if the cumulative value Q exceeds a predetermined value, the topic can be changed. Furthermore, the number of exchanges in a conversation can be counted. The cumulative value Q divided by the count N is the frequency R. If the frequency R exceeds a predetermined value, the topic can be changed. The frequency R can be used instead of the average shown in FIG. 15, and thus the topic can be changed.

When a person in a conversation with another person repeats or parrots what the other person says, it usually means that the person is not interested in the topic of conversation. In view of such a fact, the coincidence between the speech by the robot 1 and the speech by the user is measured to obtain a score. Based on the score, the topic is changed. The score can be computed by simply comparing, for example, the arrangement of words uttered by the robot 1 and the arrangement of words uttered by the user, thus obtaining the score from the number of co-occurring words.

As in the foregoing methods, the topic is changed if the score thus obtained exceeds a predetermined threshold. Alternatively, the score can be used instead of the average shown in FIG. 15, and the topic is thus changed.

Although the pattern showing indifference (obtained based on the relationship between sound pressure and time) is used in the foregoing methods, words indicating indifference can be used to trigger the change of topic. The words indicating indifference include “Uh-huh”, “Yeah”, “Oh, yeah?”, and “Yeah-yeah”. These words are registered as a group of words indicating indifference. If it is determined that one of the words included in the registered group is uttered by the user, the topic is changed.

When the user has been discussing a certain topic and pauses in the conversation, that is, when the user is slow to respond, it can be concluded that the user is not very interested in the topic and that the user in not willing to respond. The robot 1 can measure the duration of the pause until the user responds and can determine whether to change the topic based on the measured duration.

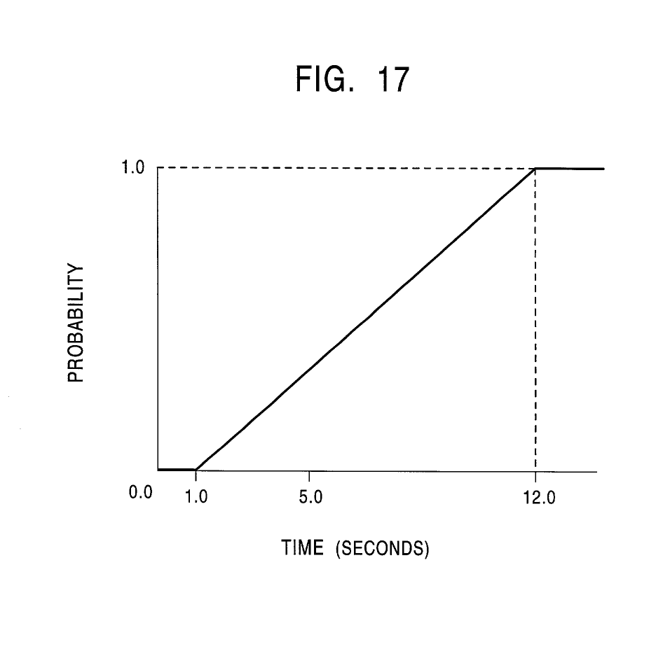

Referring to FIG. 17, if the duration of the pause until the user responds is within a range of 0.0 to 1.0 second, the topic is not changed. If the duration is within a range of 1.0 to 12.0 seconds, the topic is changed in accordance with a probability computed by a predetermined function. If the time is 12 seconds or longer, the topic is always changed. The settings shown in FIG. 17 are described by way of example, and any function and any setting can be used.

Using at least one of the foregoing methods, the timing for changing the topic is determined.

When the user makes an oral statement, such as “Enough of this topic!”, “Cut it out!”, or “Let's change the topic”, indicating the user's desire to change the topic, the topic is changed irrespective of the timing for changing the topic determined by the above-described methods.

When the conversation processor 38 of the robot 1 determines to change the topic, the subsequent topic is extracted. A process for extracting the subsequent topic is described next. When changing from the present topic A to a different topic B, it is allowable to change from the topic A to the topic B that is not related to the topic A at all. It is more desirable to change from the topic A to a topic B which is more or less related to the topic A. In such a case, the flow of conversation is not obstructed, and the conversation often tends to continue fluently. In the present embodiment, the topic A is changed to a topic B that is related to the topic A.

Information used to change the topic is stored in the topic memory 76. If the conversation processor 38 determines to change the topic using the above-described methods, the subsequent topic is extracted based on the information stored in the topic memory 76. The information stored in the topic memory 76 is described next.

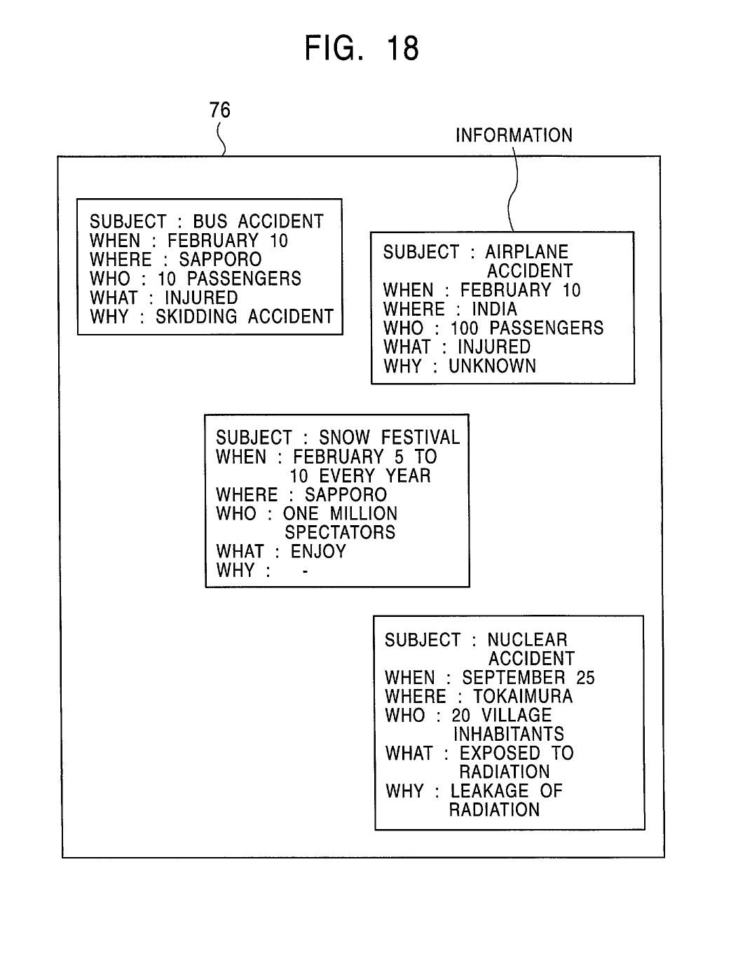

As described above, the information stored in the topic memory 76 is downloaded via a communication network such as the Internet and is stored in the topic memory 76. FIG. 18 shows the information stored in the topic memory 76. In this example, four pieces of information are stored in the topic memory 76. Each piece of information consists of items such as “subject”, “when”, “where”, “who”, “what”, and “why”. The items other than “subject” are included in the robot frame 141 and the user frame 142.

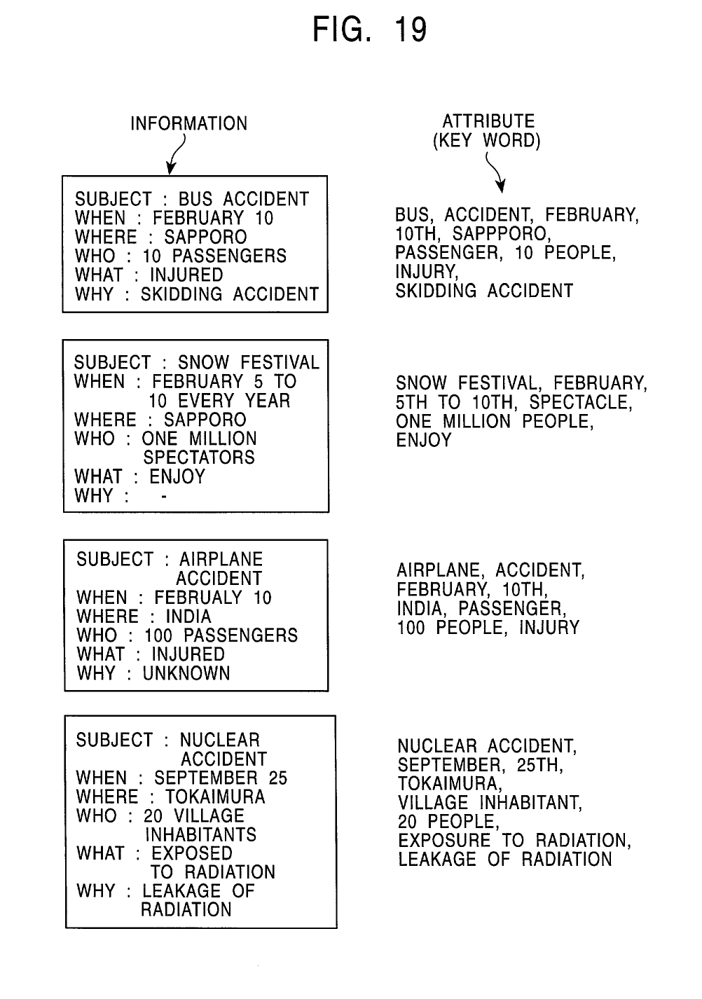

The item “subject” indicates the title of information and is provided so as to identify the content of information. Each piece of information has attributes representing the content thereof. Referring to FIG. 19, keywords are used as attributes. Autonomous words (such as nouns, verbs, and the like, which have meanings by themselves) included in each piece of information are selected and are set as the keywords. The information can be saved in a text format to describe the content. In the example shown in FIG. 18, the content is extracted and maintained in a frame structure consisting of pairs of items and values (attributes or keywords).

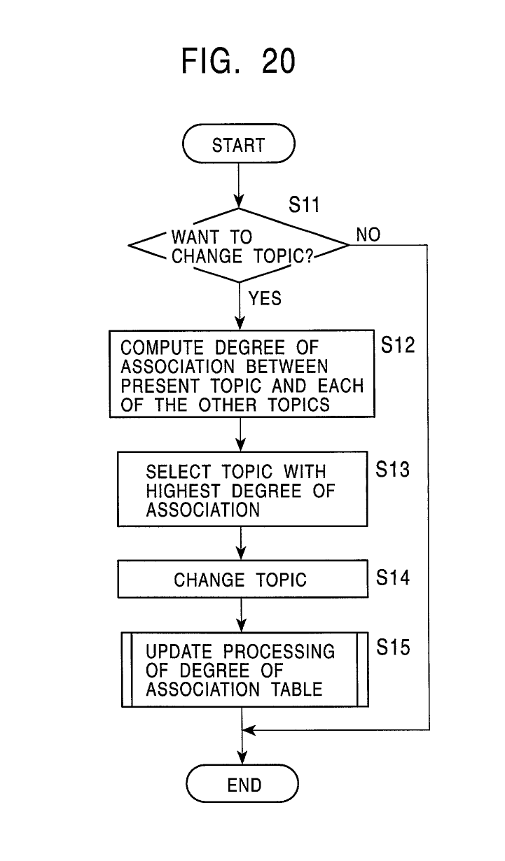

Referring to FIG. 20, a process for changing the topic by the robot 1 using the conversation processor 38 is described. In step S11, the topic manager 74 of the conversation processor 38 determines whether to change the topic using the foregoing methods. If it is determined to change the topic in step S11, the process computes, in step S12, the degree of association between the information on the present topic and the information on each of the other topics stored in the topic memory 76. The process for computing the degree of association is described next.

For example, the degree of association can be computed using a process that employs the angle made by vectors of the keywords, i.e., the attributes of the information, the coincidence in a certain category (the coincidence occurs when pieces of information in the same category or in similar categories are determined to be similar to each other), and the like. The degrees of association among the keywords can be defined in a table (hereinafter referred to as a “degree of association table”). Based on the degree of association table, the degrees of association between the keywords of the information on the present topic and the keywords of the information on the topics stored in the topic memory 76 can be computed. Using this method, the degrees of association including associations among different keywords can be computed. Hence, topics can be changed more naturally.

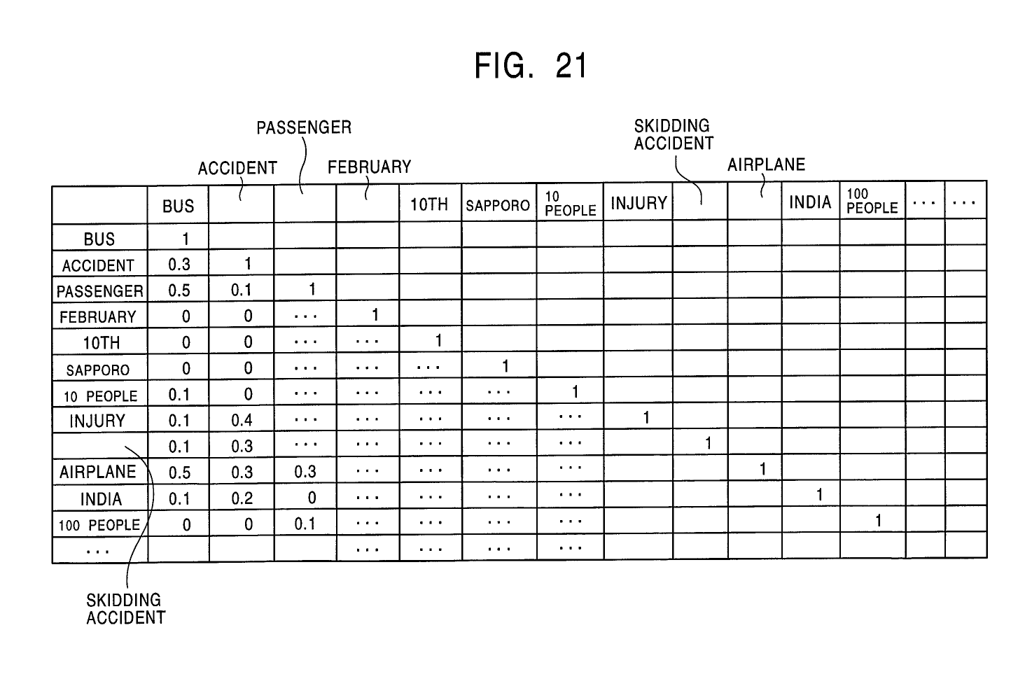

A process for computing the degrees of association based on the degree of association table is described next. FIG. 21 shows an example of a degree of association table. The degree of association table shown in FIG. 21 shows the relationship between information concerning “bus accident” and information concerning “airplane accident”. The two pieces of information to be selected to compile the degree of association table are the information on the present topic and the information on a topic which will probably be selected as the subsequent topic. In other words, the information stored in the present topic memory 77 (FIG. 5) and the information stored in the topic memory 76 are used.

The information concerning “bus accident” includes nine keywords, that is, “bus”, “accident”, “February”, “10th”, “Sapporo”, “passenger”, “10 people”, “injury”, and “skidding accident”. The information concerning “airplane accident” includes eight keywords, that is, “airplane”, “accident”, “February”, “10th”, “India”, “passenger”, “100 people”, and “injury”.

There are a total of 72 (=9×8) combinations among the keywords. Each pair of keywords is provided with a score that indicates a degree of association. The total of the scores indicates the degree of association between the two pieces of information. The table shown in FIG. 21 can be created by the server 101 (FIG. 7) for supplying information, and the created table and the information can be supplied to the robot 1. Alternatively, the robot 1 can create and store the table when downloading and storing the information from the server 101.

When the table is to be created in advance, it is assumed that both the information stored in the present topic memory 77 and the information stored in the topic memory 76 are downloaded from the server 101. In other words, when the topic memory 76 stores information on a topic presumably being discussed by the user, it is possible to use the table created in advance irrespective of whether the topic was changed by the robot 1 or by the user. However, when the user changed the topic, and when it is determined that the subsequent topic is not stored in the topic memory 76, there is no table created in advance concerning the topic introduced by the user. It is thus necessary to create a new table. A process for creating a new table is described hereinafter.

Tables are created by obtaining the degrees of association among words which statistically tends to appear in the same context frequently based on a large number of corpora, with reference to a thesaurus (a classified lexical table in which words are classified and arranged according to meaning).

Referring back to FIG. 21, the process for computing the degree of association is described using a specific example. As described above, there are 72 combinations among the keywords of the information on “bus accident” and of the information on “airplane accident”. The combinations include, for example, “bus” and “airplane”, “bus” and “accident”, and the like. In the example shown in FIG. 21, the degree of association between “bus” and “airplane” is 0.5, and the degree of association between “bus” and “accident” is 0.3.

In this manner, the table is created based on the information stored in the present topic memory 77 and the information stored in the topic memory 76, and the total of the scores is computed. When the total is computed in the foregoing manner, the scores tend to be large when the selected topics (information) have numerous keywords. When the selected topics have only a few keywords, the scores tend to be small. In order to avoid these problems, when computing the total, normalization can be performed by dividing by the number of combinations of keywords used to compute the degrees of association (72 combinations in the example shown in FIG. 21).

When changing from the topic A to the topic B, it is assumed that degree of association ab indicates the degree of association between the keywords. When changing from the topic B to the topic A, it is assumed that the degree of association ba indicates the degree of association between the keywords. When degree of association ab has the same score as that of degree of association ba, the lower left portion (or the upper right portion) of the table is used, as shown in FIG. 21. If the direction of the topic change is taken into consideration, it is necessary to use the entirety of the table. The same algorithm can be used irrespective of whether part or the entirety of the table is used.

When creating the table shown in FIG. 21 and computing the total, instead of simply computing the total, the total can be computed by taking into consideration the flow of the present topic so that the keywords can be weighted. For example, it is assumed that the present topic is that “there was a bus accident”. The keywords of the topic include “bus” and “accident”. These keywords can be weighted, and hence the total of the table including these keywords is increased. For example, it is assumed that the keywords are weighted by doubling the score. In the table shown in FIG. 21, the degree of association between “bus” and “airplane” is 0.5. When these keywords are weighted, the score is doubled to yield 1.0.

When the keywords are weighted as above, the contents of the previous topic and the subsequent topic become more closely related. Therefore, the conversation involving the change of topic becomes more natural. The table using the weighted keywords can be used (the table can be rewritten). Alternatively, the table is maintained while the keywords are weighted when computing the total of the degrees of association.

Referring back to FIG. 20, in step S12, the process computes the degree of association between the present topic and each of the other topics. In step S13, the topic with the highest degree of association, that is, the information for the table with the largest total, is selected, and the selected topic is set as the subsequent topic. In step S14, the present topic is changed to the subsequent topic, and a conversation about the new topic begins.

In step S15, the previous change of topic is evaluated, and the degree of association table is updated in accordance with the evaluation. This processing step is performed since different users have different concepts about the same topic. It is thus necessary to create a table that agrees with each user in order to hold a natural conversation. For example, the keyword “accident” reminds different users of different concepts. User A is reminded of a “train accident”, user B is reminded of an “airplane accident”, and user C is reminded of a “traffic accident”. When user A plans a trip to Sapporo and actually goes off on the trip, the same user A will have a different impression from the keyword “Sapporo”, and hence user A will advance the conversation differently.

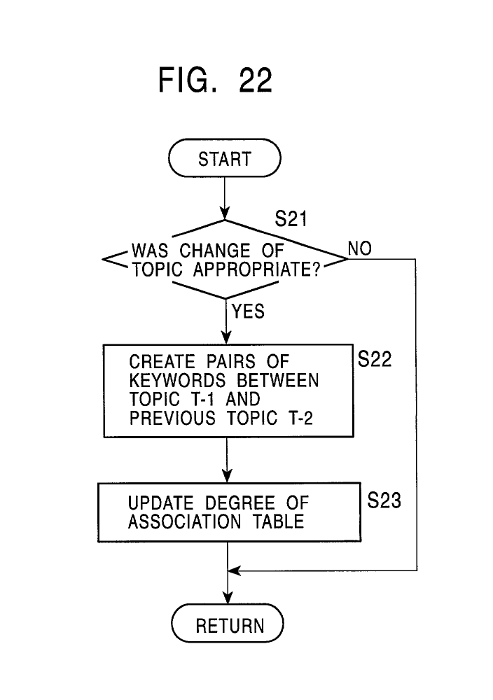

All users do not feel the same toward one topic. Also, the same user may feel differently about a topic depending on time and circumstances. Therefore, it is preferable to dynamically change the degrees of association shown in the table in order to hold a more natural and enjoyable conversation with the user. To this end, the processing in step S15 is performed. FIG. 22 shows the processing performed in step S15 in detail.

In step S21, the process determines whether the change of topic was appropriate. Assuming that the subsequent topic (expressed as topic T) in step S14 is used as a reference, the determination is performed based on the previous topic T-1 and topic T-2 before the previous topic T-1. Specifically, the robot 1 determines the amount of information on topic T-2 conveyed from the robot 1 to the user at the time topic T-2 is changed to topic T-1. For example, when topic T-2 has ten keywords, the robot 1 determines the number of keywords conveyed at the time topic T-2 is changed to topic T-1.

When it is determined that a larger number of keywords are conveyed, it can be concluded that the conversation was held for a long period of time. Whether the change of topic was appropriate can be determined by determining whether topic T-2 was changed to topic T-1 after topic T-2 had been discussed for a long period of time. This is to determine whether the user was favorably inclined to topic T-2.

If the process determines, in step S21, that the change of topic was appropriate based on the above-described determination process, the process creates, in step S22, all pairs of keywords between topic T-1 and topic T-2. In step S23, the process updates the degree of association table so that the scores of the pairs of keywords are increased. By updating the degree of association table in this manner, the change of topic tends to occur more frequently in the same combination of topics from the next time.

If the process determines, in step S21, that the change of topic was not appropriate, the degree of association table is not updated so that the information concerning the change of topic determined to be inappropriate is not used.

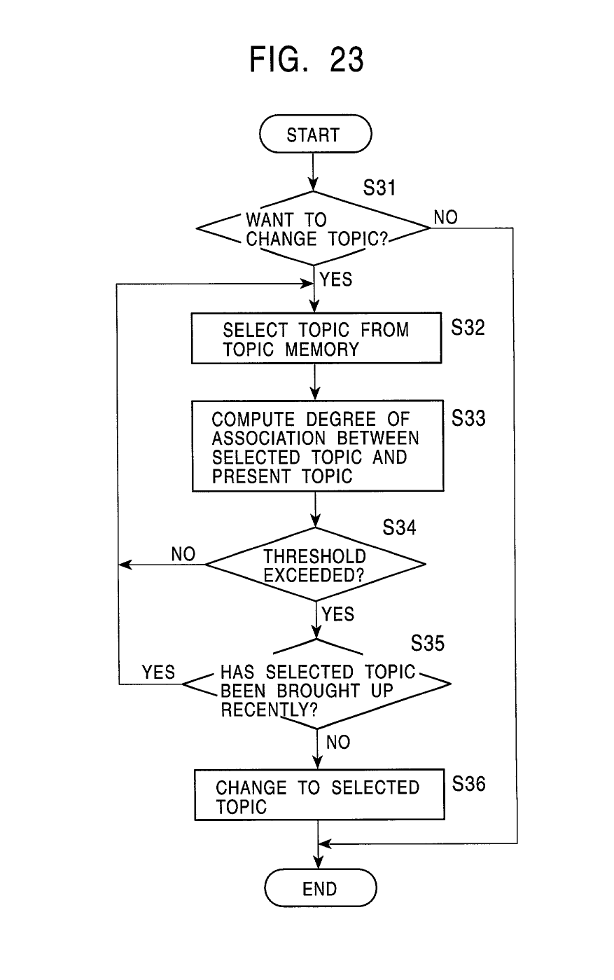

The computational overhead of determining the subsequent topic by computing the degree of association between the information stored in the present topic memory 77 and each piece of information on all the topics stored in the topic memory 76 and comparing the respective totals is high. In order to minimize the overhead, instead of computing the total of each piece of information stored in the topic memory 76, the subsequent topic is selected from among the topics, and the topic is thus changed. Referring to FIG. 23, the above-described process using the conversation processor 38 is described next.

In step S31, the topic manager 74 determines whether to change the topic based on the foregoing methods. If the determination is affirmative, in step S32, one piece of information is selected from among all the pieces of information stored in the topic memory 76. In step S33, the degree of association between the selected information and the information stored in the present topic memory 77 is computed. The processing in step S33 is performed in a manner similar to that described with reference to FIG. 20.

In step S34, the process determines whether the total computed in step S33 exceeds a threshold. If the determination in step S34 is negative, the process returns to step S32, reads information on a new topic from the topic memory 76, and repeats the processing from step S32 onward based on the selected information.

If the process determines, in step S34, that the total exceeds the threshold, the process determines, in step S35, whether the topic has been brought up recently. For example, it is assumed that the information on the topic read from the topic memory 76 in step S32 has been discussed prior to the present topic. It is not natural to again discuss the same topic, and doing so may make the conversation unpleasant. In order to avoid such a problem, the determination in step S35 is performed.

In step S35, the determination is performed by examining information in the conversation history memory 75 (FIG. 5). If it is determined by examining the information in the conversation history memory 75 that the topic has not been brought up recently, the process proceeds to step S36. If it is determined that the topic has been brought up recently, the process returns to step S32, and the processing from step S32 onward is repeated. In step S36, the topic is changed to the selected topic.

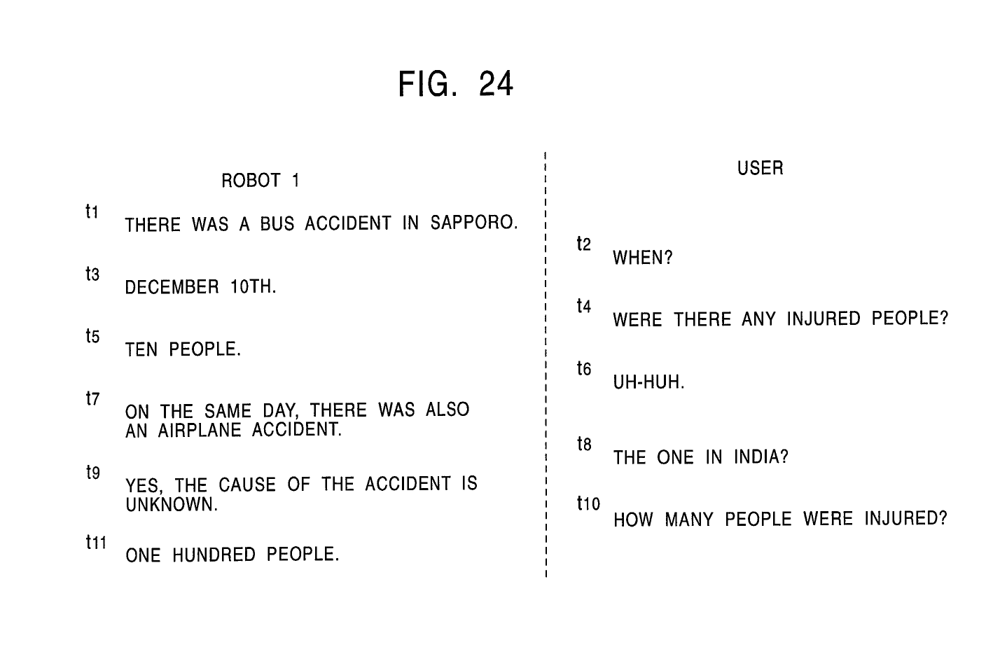

FIG. 24 shows an example of a conversation between the robot 1 and the user. At time t₁, the robot 1 selects information covering the subject “bus accident” (see FIG. 19) and begins a conversation. The robot 1 says, “There was a bus accident in Sapporo.” In response to this, the user asks the robot 1 at time t₂, “When?”. “December 10,” the robot 1 answers at time t₃. In response to this, the user asks a new question of the robot 1 at time t₄, “Were there any injured people?”.

The robot 1 answers at time t₅, “Ten people”. “Uh-huh,” the user responds at time t₆. The foregoing processes are repetitively performed during the conversation. At time t₇, the robot 1 determines to change the topic and selects a topic covering the subject “airplane accident” to be used as the subsequent topic. The topic about the “airplane accident” is selected because the present topic and the subsequent topic have the same keywords, such as “accident”, “February”, “10th”, and “injury”, and the topic about the “airplane accident” is determined to be closely related to the present topic.

At time t₇, the robot 1 changes the topic and says, “On the same day, there was also an airplane accident”. In response to this, the user asks with interest at time t₈, “The one in India?”, wishing to know the details about the topic. In response to the question, the robot 1 says to the user at time t₉, “Yes, but the cause of the accident is unknown,” so as to continue the conversation. The user is thus informed of the fact that the cause of the accident is unknown. The user asks the robot 1 at time t₁₀, “How many people were injured?”. “One hundred people,” the robot 1 answers at time t₁₁.

Accordingly, the conversation becomes natural by changing topics using the foregoing methods.

In contrast, in the example shown in FIG. 24, the user may say at time t₈, “Wait a minute. What was the cause of the bus accident?”, expressing a refusal of the change of topic and requesting the robot 1 to return to the previous topic. Alternatively, there may be a pause in the conversation about the subsequent topic. In these cases, it is determined that the subsequent topic is not acceptable to the user. The topic returns to the previous topic, and the conversation is continued.

In the above description, the case has been described in which tables concerning all the topics are created, and one table with the highest total is selected from among the tables as the subsequent topic. In this case, the topic memory 76 always stores information on a topic suitable as the subsequent topic. In other words, a topic which is not closely related to the present topic may be selected as the subsequent topic if the selected topic has a higher degree of association compared with the other topics. As the case may be, the flow of conversation may not be natural (i.e., the topic may be changed to a totally different one).

In order to avoid these problems, in the following cases, for example, in a case in which only a topic with a degree of association (total) lower than a predetermined value is available for selection as the subsequent topic, and a case in which only topics each having a total less than a threshold are detected, hence making it impossible to select a topic to be used as the subsequent topic since the selectable subsequent topic must have a degree of association total greater than the threshold, the robot 1 can be configured to utter a phrase, such as “By the way” or “As I recall”, for the purpose of signaling the user that there will be a change to a totally different topic.

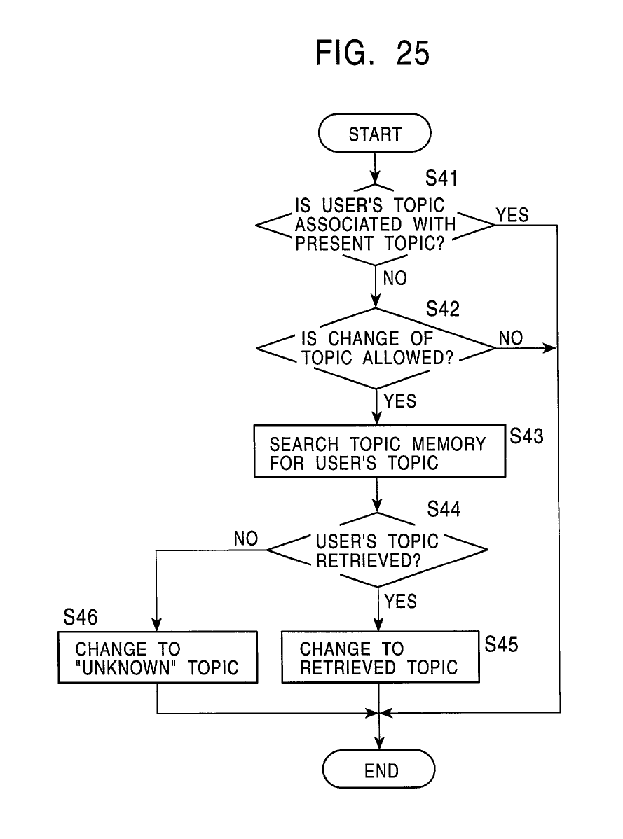

Although the robot 1 changes the topic in the above example, a case is possible in which the user changes the topic. FIG. 25 shows a process performed by the conversation processor 38 in response to the change of topic by the user. In step S41, the topic manager 74 of the robot 1 determines whether the topic introduced by the user is associated with the present topic stored in the present topic memory 77. The determination can be performed using a method similar to that for computing the degree of association between topics (keywords) when the topic is changed by the robot 1.

Specifically, the degree of association is computed between a group of keywords extracted from a single oral statement made by the user and the keywords of the present topic. If a condition concerning a predetermined threshold is satisfied, the process determines that the topic introduced by the user is related to the present topic. For example, the user says, “As I recall, a snow festival will be held in Sapporo.” Keywords extracted from the statement include “Sapporo”, “snow festival”, and the like. The degree of association between the topics is computed using these keywords and the keywords of the present topic. The process determines whether the topic introduced by the user is associated with the present topic based on the computation result.

If it is determined, in step S41, that the topic introduced by the user is associated with the present topic, the process is terminated since it is not necessary to track the change of topic by the user. In contrast, if it is determined, in step S41, that the topic introduced by the user is not associated with the present topic, the process determines, in step S42, whether the change of topic is allowed.

The process determines whether the change of topic is allowed in accordance with a rule such that if the robot 1 has any undiscussed information covering the present topic, the topic must not be changed. Alternatively, the determination can be performed in a manner similar to the processing performed when the topic is changed by the robot 1. Specifically, when the robot 1 determines that the timing is not appropriate for changing the topic, the change of topic is not allowed. However, such settings enable only the robot 1 to change topics. When the change of topic is introduced by the user, it is necessary to perform processing such as to set a probability so as to enable the user to change the topic.

If the process determines, in step S42, that the change of topic is not allowed, the process is terminated since the topic is not changed. In contrast, if the process determines, in step S42, that the change of topic is allowed, the process searches, in step S43, the topic memory 76 for the topic introduced by the user in order to detect the topic introduced by the user.

The topic memory 76 can be searched for the topic introduced by the user using a process similar to that used in step S41. The process determines the degrees of association (or the total thereof) between the keywords extracted from the oral statement made by the user and each of the keyword groups of the topics (information) stored in the topic memory 76. Information with the largest computation result is selected as a candidate for the topic introduced by the user. If the computation result of the candidate is equal to a predetermined value or greater, the process determines that the information agrees with the topic introduced by the user. Although the process has a high probability of success in retrieving the topic that agrees with the user's topic and thus is reliable, the computational overhead of the process is high.

In order to minimize the overhead, one piece of information is selected from the topic memory 76, and the degree of association between the user's topic and the selected topic is computed. If the computation result exceeds a predetermined value, the process determines that the selected topic agrees with the topic introduced by the user. The process is repeated until the information with a degree of association exceeding the predetermined value is detected. It is thus possible to retrieve the topic to be taken up as the topic introduced by the user.

In step S44, the process determines whether the topic which is taken up as the topic introduced by the user is retrieved. If it is determined, in step S44, that the topic is retrieved, the process transfers, in step S45, the retrieved topic (information) to the present topic memory 77, thereby changing the topic.

In contrast, if the process determines, in step S44, that the topic is not retrieved, that is, there is no information with a total of degrees of association exceeding the predetermined value, the process proceeds to step S46. This indicates that the user is discussing information other than that known to the robot 1. Hence, the topic is changed to an “unknown” topic, and the information stored in the present topic memory 77 is cleared.

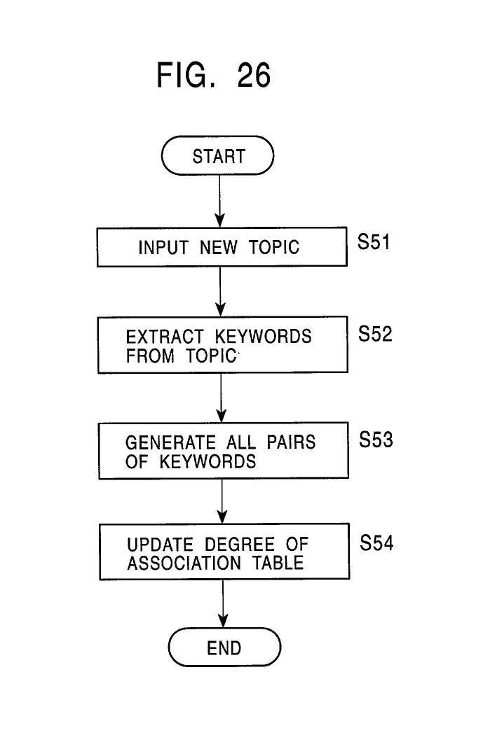

When the topic is changed to an “unknown” topic, the robot 1 continues the conversation by asking questions of the user. During the conversation, the robot 1 stores information concerning the topic stored in the present topic memory 77. In this manner, the robot 1 updates the degree of association table in response to the introduction of the new topic. FIG. 26 shows a process for updating the table based on a new topic. In step S51, a new topic is input. A new topic can be input when the user introduces a topic or presents information unknown to the robot 1 or when information n is downloaded via a network.

When a new topic is input, the process extracts keywords from the input topic in step S52. In step S53, the process generates all pairs of the extracted keywords. In step S54, the process updates the degree of association table based on the generated pairs of keywords. Since the processing performed in step S54 is similar to that performed in step S23 of the process shown in FIG. 21, a repeated description of the common portion is omitted.

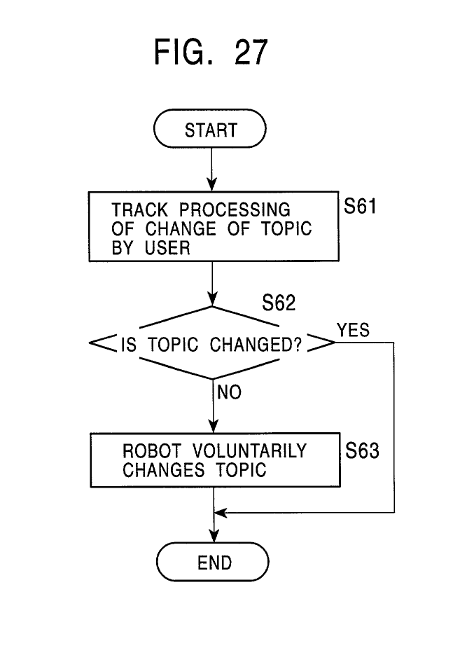

In actual conversations, there are cases in which topics are changed by the robot 1 and other cases in which topics are changed by the user. FIG. 27 outlines a process performed by the conversation processor 38 in response to the change of topic. Specifically, in step S61, the process tracks the change of topic introduced by the user. The processing performed in step S61 corresponds to the process shown in FIG. 25.

As a result of the processing in step S61, the process determines, in step S62, whether the topic is changed by the user. Specifically, if it is determined, in step S41 in FIG. 25, that the topic introduced by the user is associated with the present topic, the process determines, in step S62, that the topic is not changed. In contrast, if it is determined, in step S41, that the topic introduced by the user is not associated with the present topic, the processing from step S41 onward is performed, and the process determines, in step S62, that the topic is changed.

If the process determines, in step S62, that the topic is not changed, the robot 1 voluntarily changes the topic in step S63. The processing performed in step S63 corresponds to the processes shown in FIG. 20 and FIG. 23.

In this manner, the change of topic by the user is given priority over the change of topic by the robot 1, and hence the user is given the initiative in the conversation. In contrast, when step S61 is replaced with step S63, the robot 1 is allowed the initiative in the conversation. Using such facts, when the robot 1 has been indulged by the user, the robot 1 can be configured to take the initiative in conversation. When the robot 1 is well disciplined, it can be configured so that the user takes the initiative in conversation.

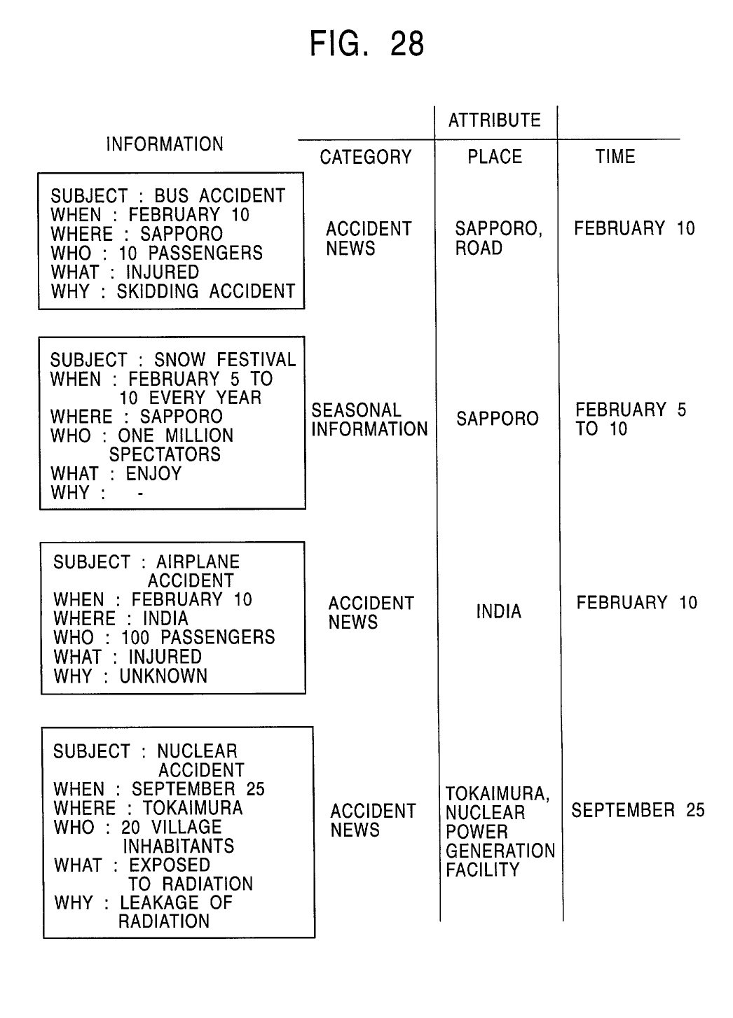

In the above-described example, keywords included in information are used as attributes. Alternatively, attribute types such as category, place, and time can be used, as shown in FIG. 28. In the example shown in FIG. 28, each attribute type of each piece of information generally includes only one or two values. Such a case can be processed in a manner similar to that for the case of using keywords. For example, although “category” basically includes only one value, “category” can be treated as an exceptional example of an attribute type having a plurality of values, such as “keyword”. Therefore, the example shown in FIG. 28 can be treated in a manner similar to the case of using “keyword” (i.e., tables can be created).

It is possible to use a plurality of attribute types, such as “keyword” and “category”. When using a plurality of attribute types, the degrees of association are computed in each attribute type, and a weighted linear combination is computed as the final computation result to be used.

It has been described that the topic memory 76 stores topics (information) which agree with the user's preferences (profile) in order to cause the robot 1 to hold natural conversations and to change topics naturally. It has also been described that the profile can be obtained by the robot 1 during conversations with the user or by connecting the robot 1 to a computer and inputting the profile to the robot 1 using the computer. A case is described below by way of example in which the robot 1 creates the profile of the user based on a conversation with the user.

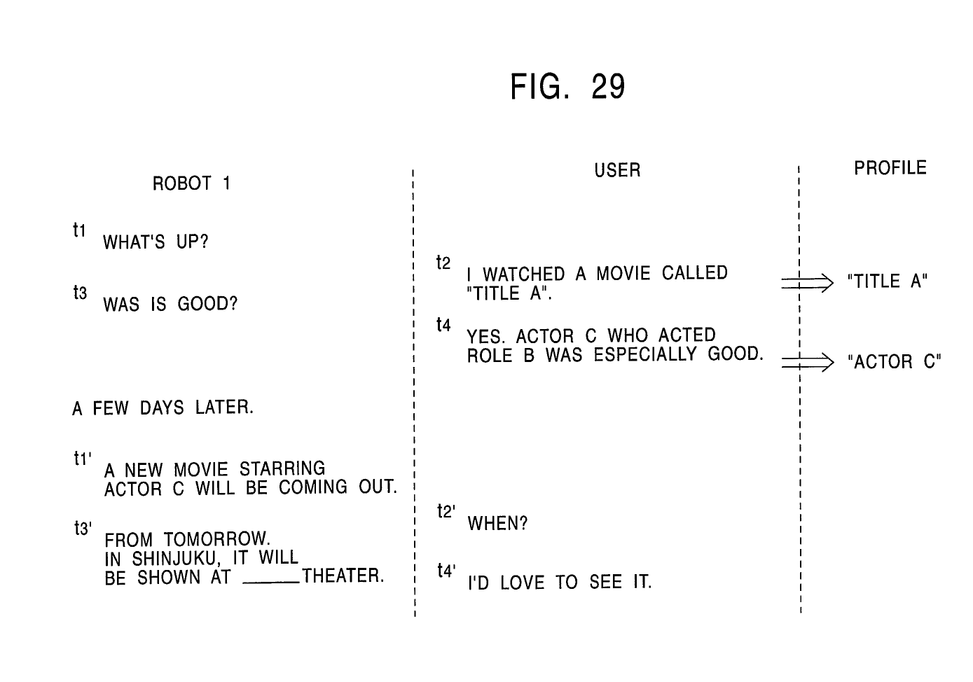

Referring to FIG. 29, the robot 1 asks the user at time t₁, “What's up?”. The user responds to the question at time t₂, “I watched a movie called ‘Title A’”. Based on the response, “Title A” is added to the profile of the user. The robot 1 asks the user at time t₃, “Was it good?”. “Yes. Actor C who acted Role B was especially good,” the user responds as time t₄. Based on the response, “Actor C” is added to the profile of the user.

In this manner, the robot 1 obtains the user's preferences from the conversation. When the user responds at time t4, “It wasn't good”, “Title A” may not be added to the profile of the user since the robot 1 is configured to obtain the user's preferences.

A few days later, the robot 1 downloads information from the server 101, which indicate that “a new movie called ‘Title B’ starring Actor C”, “the new movie will open tomorrow”, and “the new movie will be shown at _ Theater in Shinjuku.” Based on the information, the robot 1 says to the user at time t₁′, “A new movie starring Actor C will be coming out”. The user praised Actor C for his acting a few days ago, and the user is interested in the topic. The user asks the robot 1 at time t₂′, “When?”. The robot 1 has already obtained the information concerning the opening date of the new movie. Based on the information (profile) on the user's nearest mass transit station, the robot 1 can obtain information concerning the nearest movie theater. In this example, the robot 1 has already obtained this information.

The robot 1 responds to the user's question at time t₃′ based on the obtained information, “From tomorrow. In Shinjuku, it will be shown at _ Theater”. The user is informed of the information and says at time t4′, “I'd love to see it”.

In this manner, the information based on the profile of the user is conveyed to the user in the course of conversations. Accordingly, it is possible to perform advertising in a natural manner. Specifically, the movie called “Title B” is advertised in the above example.

Advertising agencies can use the profile stored in the server 101 or the profile provided by the user and can send advertisements by mail to the user so as to advertise products.

Although it has been described in the present embodiment that conversations are oral, the present invention can be applied to conversations held in written form.

The foregoing series of processes can be performed by hardware or by software. When performing the series of processes by software, a program constructing that software is installed from recording media in a computer incorporated in special-purpose hardware, or in a general-purpose personal computer capable of performing various functions by installing various programs.

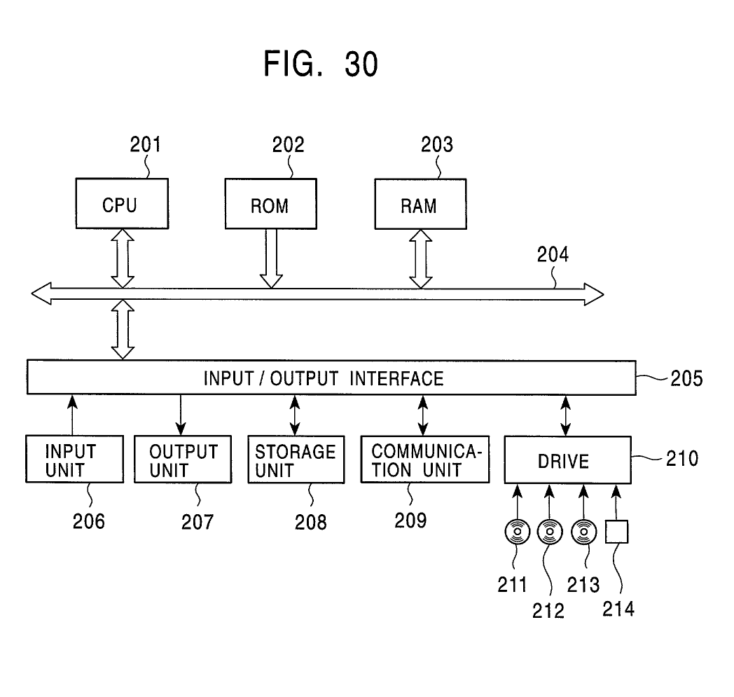

Referring to FIG. 30, the recording media include packaged media supplied to the user separately from a computer. The packaged media include a magnetic disk 211 (including a floppy disk), an optical disk 212 (including a compact disk-read only memory (CD-ROM) or a digital versatile disk (DVD)), a magneto-optical disk 213 (including a mini-disk (MD)), a semiconductor memory 214, and the like. Also, the recording media include a hard disk installed beforehand in the computer and thus provided to the user, which includes a read only memory (ROM) 202 and a storage unit 208 for storing the program.

In the present description, steps for writing a program provided by the recording media not only include time-series processing performed in accordance with the described order but also include parallel or individual processing, which may not necessarily be performed in time series.

In the present description, the system represents an overall apparatus formed by a plurality of units.

What is claimed is:

1. A conversation processing apparatus for holding a conversation with a user, comprising:
first storage means for storing a plurality of pieces of first information concerning a plurality of topics;
second storage means for storing second information concerning a present topic being discussed;
determining means for determining whether to change the topic;
selection means for selecting, when said determining means determines to change the topic, a new topic to change to from among the topics stored in said first storage means; and
changing means for reading the first information concerning the topic selected by said selection means from said first storage means and for changing the topic by storing the read information in said second storage means.

2. A conversation processing apparatus according to claim 1, further comprising:
third storage means for storing a topic which has been discussed with the user in a history;
wherein said selection means selects, as the new topic, a topic other than those stored in the history in said third storage means.

3. A conversation processing apparatus according to claim 1, wherein, when said determination means determines to change the topic in response to the change of topic introduced by the user, said selection means selects a topic which is the most closely related to the topic introduced by the user from among the topics stored in said first storage means.

4. A conversation processing apparatus according to claim 1, wherein:
the first information and the second information include attributes which are respectively associated therewith;
said selection means selects the new topic by computing a value based on association between the attributes of each piece of the first information and the attributes of the second information and selecting the first information with the greatest value as the new topic, or by reading a piece of the first information, computing the value based on the association between the attributes of the first information and the attributes of the second information, and selecting the first information as the new topic if the first information has a value greater than a threshold.

5. A conversation processing apparatus according to claim 4, wherein the attributes include at least one of a keyword, a category, a place, and a time.

6. A conversation processing apparatus according to claim 4, wherein the value based on the association between the attributes of the first information and the attributes of the second information is stored in the form of a table, said table being updated.

7. A conversation processing apparatus according to claim 6, wherein, when selecting the new topic using the table, said selection means weights the value in the table for the first information having the same attributes as those of the second information and uses the weighted table, thereby selecting the new topic.

8. A conversation processing apparatus according to claim 1, wherein the conversation is held in one of orally and in written form.

9. A conversation processing apparatus according to claim 1, wherein said conversation processing apparatus is included in a robot.

10. A conversation processing method for a conversation processing apparatus for holding a conversation with a user, comprising:
a storage controlling step of controlling storage of information concerning a plurality of topics;
a determining step of determining whether to change the topic;
a selecting step of selecting, when the topic is determined to be changed in said determining step, a topic which is determined to be appropriate as a new topic from among the topics stored in said storage controlling step; and
a changing step of using the information concerning the topic selected in said selecting step as information concerning the new topic, thereby changing the topic.

11. A recording medium having recorded thereon a computer-readable conversation processing program for holding a conversation with a user, the program comprising:
a storage controlling step of controlling storage of information concerning a plurality of topics;
a determining step of determining whether to change the topic;
a selecting step of selecting, when the topic is determined to be changed in said determining step, a topic which is determined to be appropriate as a new topic from among the topics stored in said storage controlling step; and
a changing step of using the information concerning the topic selected in said selecting step as information concerning the new topic, thereby changing the topic.
